(19) United States
(12) Patent Application Publication
(10) Pub. No.: US 2021/0214174 A1
(43) Pub. Date: Jul. 15, 2021

(54) SYSTEM, METHOD, AND LAYOUT FOR LOADING, UNLOADING, AND MANAGING SHIPPING CONTAINERS AND PASSENGER CONTAINERS TRANSPORTED BY MONORAIL, MAGLEV LINE, GROOVED PATHWAY, ROADWAY, OR RAIL TRACKS

(71) Applicant: WICKEDHYPER, LLC, NEW ORLEANS, LA (US)

(72) Inventor: Steven M. PEASLEE, Alexandria, LA (US)

(73) Assignee: WICKEDHYPER, LLC, NEW ORLEANS, LA (US)

(21) Appl. No.: 17/133,522

(22) Filed: Dec. 23, 2020

Related U.S. Application Data
(60) Provisional application No. 63/019,811, filed on May 4, 2020.
(60) Provisional application No. 62/953,336, filed on Dec. 24, 2019.

(51) Int. Cl. B65G 63/02; B61D 47/00; B61D 3/20

(52) U.S. Cl. CPC B65G 63/025; B61D 3/20; B61D 47/005

(57) ABSTRACT

A transportation system and method for transporting cargo containers and/or passenger containers between one or more locations includes terminal facilities having a small footprint, e.g., three to six acres (12,140.6 to 24, 281.1 square m). Cargo containers and/or passenger containers can be stored at terminal facilities. Cargo and/or passenger container vehicles and automated guidance vehicles can be maintained and recharged at terminal facilities. The transportation system and method preferably combine aspects of hyperloop technology with both monorail and traditional rail technologies and includes an on-demand movement of automated or manual individual vehicles or trainsets carrying shipping containers and/or passenger containers along a dedicated track or transportation line. The system and method can combine automated and manual operations and preferably includes: electrically-powered vehicles that are propelled by magnetic levitation, conventional electric power, and/or linear electric propulsion and designed to transport shipping containers and passenger containers along the same line; load/unload zones; maintenance zones; recharge zones; storage zones, turntables for negotiating tight right-of-way scenarios; forecasting/alleviating ground settlement effects; and refrigerated container movement.

### CROSS-REFERENCE TO RELATED APPLICATIONS

Priority to and/or the benefit of U.S. Provisional Patent Application Ser. No. 63/019,811, filed on 4 May 2020, and U.S. Provisional Patent Application Ser. No. 62/953,336, filed on 24 Dec. 2019 is hereby claimed and each of which is hereby incorporated herein by reference.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

### 1. Field of the Invention

The present invention relates to a system and method for transporting cargo containers and/or passenger containers between one or more locations, including between port and inland locations, loading/unloading those containers onto/off from that transport mode, and wherein terminal facilities have a relatively small footprint. The present invention also relates to handling cargo containers and/or passenger containers at terminal locations and repairing/maintaining transport/cargo container vehicles at terminal locations. The transportation mode sometimes referred to herein as Hyperrail™, preferably combines some aspects of innovative hyperloop technology with both monorail and conventional rail technologies and includes an on-demand movement of driver or driverless vehicles for carrying one or more shipping containers along a dedicated track or transportation line. The system and method preferably combines automated and manual operations and can include: Hyperrail™ electrically powered driver or driverless vehicles that employ innovative propulsion technologies and are designed to transport shipping containers and/or passenger containers; load zones for loading/unloading shipping containers at transportation line terminals; maintenance zones for maintaining/servicing vehicles; traffic lane patterns for automated guidance vehicles operating in and around load zones; infrastructure for negotiating tight right-of-way scenarios; passenger transportation combined with freight transportation on the transportation line; forecasting/alleviating ground settlement effects; and maximizing efficiency for refrigerated container movement.

### 2. General Background of the Invention

The storage, handling, and movement of containers, e.g., shipping containers or cargo containers, in the prior art requires significant space. Transport of containers is typically done by railways, roadways, and/or waterways. Container ports are constrained by space limitations near the waterfront because of availability, cost, and geography. There is little or no room for footprint expansion or growth at current port facilities, and potential future port locations are constrained by the aforementioned real estate requirements.

Due to congestion, high costs, and limited efficiencies, container seaports around the world seek to move many of their operations further inland to “dry” ports or intermodal transfer locations, thereby freeing up valuable waterfront property for essential equipment/operations and port expansion. Tens of thousands of stacked shipping containers—many of these empty—occupy valuable port space that could otherwise be used to facilitate growth. Rail yards located within a port's boundaries require massive footprints, usually in excess of 30 acres (0.1214 square km), not including the additional space used for loading/unloading, eating up valuable limited acreage or land/property. The challenge has been to find an efficient and thrifty means by which to achieve such a shift of operations from waterfront to inland. Traditionally, even when these shifts have been contemplated, the mindset has been restricted to some combination of conventional rail and truck transportation as the only reasonably available modes of transport to move container freight from a port to an inland facility. Both of these modes have significant shortcomings, including a demonstrated unfriendliness to the environment due to heavy carbon emissions, and neither successfully meets the challenge of effectively shrinking needed waterfront real estate.

Hyperloop-related innovative rail transportation technologies have emerged, e.g., see U.S. Pat. No. 10,493,859, which involve on-demand movement of shipping containers by maglev (magnetic levitation) rail via Virgin Hyperloop One's conceptual VHO Runner, as well as by conventional rail via Virgin Hyperloop One's Cargospeed™. Hyperloop-based providers, however, are focused solely on the Hyperrail™ line and vehicle, providing high-speed, driverless, cargo container transportation from point A to point B, with no solution for operations at the terminal ends, including loading/unloading of containers, maintenance/recharging (if necessary) of vehicles, container movement to/from Hyperrail™ lines/vehicles, and passenger embarkation/debarkation.

In the prior art, at a container port/terminal, containers are unloaded from the incoming ship onto yard trucks which then bring them to a section on the terminal known as the container yard. Here the yard trucks are unloaded by rubber tired gantries (RTG) or rail mounted gantries (RMC) and the containers are placed in stacks. The containers are eventually removed (again by RTG/RMC) from their stacks and loaded onto a freight truck (drayage) or a freight train if there is a rail yard at the port. At an off-dock rail yard, containers are loaded and unloaded using RTG/RMC's and yard trucks also. There is another crane vehicle known as a reach stacker that can both lift and carry a container around the yard. The rail yard is also set up with container stacks awaiting the appropriate unit train before being loaded. As shown and described herein, the various embodiments of the system and method of the present invention solve problems in the prior art in a novel way that increases efficiency, saves time and cost, reduces the foot print needed at a terminal facility, and reduces the environmental impact at a terminal facility and with transport of shipping containers.

The following patents and patent publications are incorporated herein by reference.

| | | Issue/ |
|---|---|---|
| Patent/ | | Publication Date |
| Publication No. | Title | MM/DD/YYYY |
| 9,505,559 | DEDICATED NETWORK | 11/29/2016 |
| | DELIVERY SYSTEMS | |
| 9,718,564 | GROUND-BASED MOBILE | 08/01/2017 |
| | MAINTENANCE FACILITIES FOR | |
| | UNMANNED AERIAL VEHICLES | |
| 10,286,927 | TUBE TRANSPORTATION | 05/14/2019 |
| | SYSTEMS USING A GASEOUS | |
| | MIXTURE OF AIR AND HELIUM | |
| 10,286,928 | METHOD OF USING AIR AND | 05/14/2019 |
| | HELIUM IN LOW-PRESSURE | |
| | TUBE TRANSPORTATION | |
| | SYSTEMS | |
| 10,370,204 | TRANSPORTATION SYSTEM | 08/06/2019 |
| 10,450,705 | MAGNETIC LEVITATION TRAIN | 10/22/2019 |
| | SYSTEM | |
| 10,476,408 | METHOD OF CONTROLLING | 11/12/2019 |
| | PROPULSION AND SUSPENSION | |
| | OF LINEAR INDUCTION | |
| | MOTORS | |
| 10,493,859 | STATION WITH LOOP | 12/03/2019 |
| | CONFIGURATION FOR | |
| | HYPERLOOP TRANSPORTATION | |
| | SYSTEM | |
| 2017/0280124 | AUGMENTED WINDOWS | 09/28/2017 |
| 2017/0334312 | STATION WITH LOOP | 11/23/2017 |
| | CONFIGURATION FOR | |
| | HYPERLOOP TRANSPORTATION | |
| | SYSTEM | |
| 2018/0051735 | TWIST LOCK SWIVEL/TWIST | 02/22/2018 |
| | LOCK COUPLING | |
| 2018/0265296 | DEMAND-BASED DISTRIBUTION | 09/20/2018 |
| | OF ITEMS USING INTERMODAL | |
| | CARRIERS AND UNMANNED | |
| | AERIAL VEHICLES | |
| 2019/0249552 | ROADWAY CONDUIT SYSTEMS | 08/15/2019 |
| | AND METHODS | |
| 2020/0001898 | METHOD OF USING AIR AND | 01/02/2020 |
| | HELIUM IN LOW-PRESSURE | |
| | TUBE TRANSPORTATION | |
| | SYSTEM | |
| 2020/0001899 | TUBE TRANSPORTATION | 01/02/2020 |
| | SYSTEMS USING A GASEOUS | |
| | MIXTURE OF AIR AND | |
| | HYDROGEN | |
| 2020/0001900 | METHOD OF USING AIR AND | 01/02/2020 |
| | HYDROGEN IN LOW PRESSURE | |
| | TUBE TRANSPORTATION | |
| WO2018/ | MOBILE FULFILLMENT | 09/20/2018 |
| 169695 | CENTERS WITH INTERMODAL | |
| | CARRIERS AND UNMANNED | |
| | AERIAL VEHICLES | |

The follow documents and web pages are incorporated herein by reference.
An automated gantry crane as a large workspace robot, Control Engineering Practice 10 (2002) 1323-1338.
https://hyperloop-one.com/facts-frequently-asked-questions
https://hyperloop-one.com/blog/how-and-why-were-levitating
https://www.konecranesusa.com/equipment/container-handling-equipment/rubber-tired-gantry-cranes
https://cranedepot.com/collections/heavy-duty-gantry-cranes?ppc_keyword=gantry %20cr
https://cnbc.com/2019/02/10/dp-world-plans-to-launch-its-first-hyperloop-for-cargo-in-india.html
https://www.gbrx.com/manufacturing/north-America-rail/intermodal-units/maxi-stack-i-car/BRIEF

### SUMMARY OF THE INVENTION

The apparatuses, systems and methods of the present invention solve the problems confronted in the art in a simple and straightforward manner What is provided in one or more preferred embodiments is a transportation mode that combines some of the emerging technologies of hyperloop with those of both monorail and conventional rail, reflected in an on-demand movement of individual vehicles, sometimes referred to herein as pods, along a dedicated track or transportation line. One or more preferred embodiments of the system and mode of the present invention is referred to sometimes herein as the Hyperrail™ transportation system or mode.

The vehicles or pods used in one or more preferred embodiments of the present invention are preferably electrically powered (hence, more environmentally friendly), may be propelled by magnetic levitation, linear movement, wheeled movement, or other desired means and are designed to carry fully-loaded standard shipping containers, e.g., either an FEU (Forty-foot (12.19 meter (m)) Equivalent Unit) or two TEUs (Twenty-foot (6.096 m) Equivalent Units) per vehicle, the total weighing as much as 35 tons (31,751.5 kilograms (kg)), for example, and may include the capacity to transport refrigerated container units. In other embodiments, non-standard sized shipping containers can be used if desired.

In other preferred embodiments, multiple vehicles or pods can be connected to form a trainset, and can carry multiple fully-loaded shipping containers, e.g., standard sized two FEUs or four TEUs per vehicle or pod. In these embodiments a vehicle or pod will be sometimes referred to herein as a train vehicle or train pod. In these embodiments, 3, 4, 5, 6, 7, 8, 9, or 10 or more cargo containers, e.g., preferably FEUs, can be transported at one time on a single trainset composed of multiple train vehicles or train pods.

In other embodiments, 4, 6, 8, 10, 12, 14, 16, 18, 20 or more cargo containers, e.g., preferably TEUs can be transported at one time on a single trainset composed of multiple train vehicles or train pods.

In other embodiments trainsets can include 2 to 20 or more cargo containers with a mix of FEU containers and TEU containers or other desired containers. For example, about 80% of the containers on a trainset can be FEUs and the remainder being a mix of TEUs or other containers.

Having a trainset may be desirable to lower overall cost in a Hyperrail™ transportation system, given that fewer vehicles or pods are needed to transport the same amount of cargo containers. When using a trainset, cost may be saved with respect to the transportation lines and vehicles or pods, especially the powered vehicles, but additional land/space, cranes, and automated guidance vehicles (AGVs) may be needed at terminal ends to accommodate the longer trainsets. An AGV preferably is driver-less, electric.

Preferably, if trainsets are used in a transportation system and method of the present invention, the vehicles or pods are adapted to carry multiple cargo containers, while at the same time, terminals can still have a smaller footprint (e.g., preferably no more than five acres (20,234.3 square m)) than the 30-plus acres (121,406 plus square m) required for a conventional train railway system that typically uses trains of approximately 120 cars stretching more than a mile (1.609 km) long.

The vehicles or pods used in the Hyperrail™ transportation mode, including individual cargo container vehicles or pods and trainsets, are preferably driver or driverless and preferably controlled by operations towers incorporating digital freight-forwarding software that “call” shipping containers (e.g., tagged by RFID or similar identification methods) forward to be moved from one terminal of a transportation line to another terminal, or from a terminal storage facility to a another terminal. An example of digital freight-forwarding software that can be used in one or more preferred embodiments of the present invention includes software sold under the trademark Flexport™ and available from Flexport Customs, LLC. An example of a Hyperrail™ vehicle or pod that can be used in one or more preferred embodiments of the present invention is a VHO Cargospeed™ currently under development at Virgin Hyperloop One.

Because the transportation mode of the present invention can be configured to dispatch vehicles or pods as rapidly as needed, the rate-determining factor for the velocity of the entire system becomes the speed at which shipping containers can be loaded/off-loaded at each end of a transportation line, referred to herein as the “lift speed”. The maximum lift speed of the present invention is preferred to match the combined maximum lift speed of the cranes loading/off-loading a container ship at a designated pier or piers. In this way, containers only move from ship to AGV to Hyperrail™, and vice-versa in the opposite direction, without touching the seaport surface. This operational efficiency removes the need for container yards dedicated to stacking of FEUs at the port, freeing up yet additional large amounts of space.

In one or more preferred embodiments, in a system and/or method including 1 gantry spreader in each direction (2 total) for inbound and outbound transportation lines using pods or vehicles that can carry 1 FEU cargo container, a maximum cargo container lift rate can be 90 FEUs per hour (each direction), with about 1.5 cars per minute in a one-phase cycle with a cycle time of about 40 seconds, which can result in about 3.15 million cargo containers per year with 24 hr/365 day operation. With 70% of that operation time, about 2.21 million cargo containers per year can be loaded/offloaded.

In one or more preferred embodiments, in a system and/or method including 2 gantry spreaders in each direction (4 total) for inbound and outbound transportation lines using pods or vehicles that can carry 1 FEU cargo container, a maximum cargo container lift rate can be 180 FEUs per hour (each direction), with about 3 cars per minute in a two-phase cycle with a cycle time of about 40 seconds, which can result in about 6.31 million cargo containers per year with 24 hr/365 day operation. With 70% of that operation time, about 4.42 million cargo containers per year can be loaded/offloaded.

In one or more preferred embodiments, in a system and/or method including 3 gantry spreaders in each direction (6 total) for inbound and outbound transportation lines using pods or vehicles that can carry 1 FEU cargo container, a maximum cargo container lift rate can be 240 FEUs per hour (each direction), with about 4 cars per minute in a three-phase cycle with a cycle time of about 45 seconds, which can result in about 8.41 million cargo containers per year with 24 hr/365 day operation. With 70% of that operation time, about 5.89 million cargo containers per year can be loaded/offloaded In one or more preferred embodiments, in a system and/or method including 2 gantry spreaders in each direction (4 total) for inbound and outbound transportation lines using pods or vehicles that can carry 2 FEUs (also referred to as a 2×FEU car), a maximum cargo container lift rate can be about 180 FEUs per hour (each direction), with about 1.5 2×FEU cars per minute in a one-phase cycle with a cycle time of about 40 seconds, which can result in about 6.31 million cargo containers per year with 24 hr/365 day operation. With 70% of that operation time, about 4.42 million cargo containers per year can be loaded/offloaded.

In one or more preferred embodiments, in a system and/or method including 4 gantry spreaders in each direction (8 total) for inbound and outbound transportation lines using pods or vehicles that can carry 2 FEUs (also referred to as a 2×FEU car), a maximum cargo container lift rate can be about 360 FEUs per hour (each direction), with 3 2×FEU cars per minute in a two-phase cycle with a cycle time of about 40 seconds, which can result in about 12.6 million cargo containers per year with 24 hr/365 day operation. With 70% of that operation time, about 8.8 million cargo containers per year can be loaded/offloaded.

In one or more preferred embodiments, in a system and/or method including 10 total gantry spreaders and using train pods or train vehicles that can carry 10 FEUs (also referred to as a 10×FEU trainset), a maximum cargo container lift rate can be 300 FEUs per hour (each direction), with 0.5 10×FEU trainsets per minute in a two-phase cycle with a cycle time of about 60 seconds, which can result in about 10.5 million cargo containers per year with 24 hr/365 day operation. With 70% of that operation time, about 7.4 million cargo containers per year can be loaded/offloaded.

Containers other than FEU's can also be used in the above-referenced examples if desired.

Comparatively, it would require twenty-five (25) double-stacked 120-car trains per day, 365 days/year, each carrying 240 FEUs, to achieve the same 2.21 million container volume as the least robust WickedHyper™ system described above running 70% of the time. Because one or more preferred embodiments of the system and method of the present invention entails a series of individual vehicles or pods, or short trainsets, rather than long conventional trains of connected freight cars, the space requirements to load/unload the vehicles or pods is a fraction of that needed for a lengthy rail segment (a 120-car train, for example, is more than one mile (1.609 km) long) with multiple sidings. Similarly, the trucking component that would be needed to transport an equivalent amount of cargo—over 6,000 trucks daily, each carrying an FEU or two TEUs every day of the year—also presents significant stresses on the limited port resources, especially the requirement for drivers (and benefits), port gates, accelerated road wear and tear, and traffic management. The carbon footprint of such truck traffic is generally viewed as excessive and unacceptable in current port and infrastructure planning.

In one or more preferred embodiments of the system and method of the present invention, various elements of a transportation rail or line are addressed beyond the actual propulsion system, track, electrical source, vehicle, and point-to-point vehicle controls (e.g., acceleration/deceleration, braking). Included in one or more preferred embodiments of the system and method of the present invention are solutions for loading/unloading shipping containers at transportation line terminals (e.g., ports, rail yards, distribution centers), maintaining/recharging vehicles or pods, negotiating tight right-of-way scenarios, enabling passenger transportation on the same transportation line with cargo containers, forecasting/alleviating ground settlement effects, and maximizing efficiency for refrigerated container movement. One or more preferred embodiments of the system and method of the present invention blends automated operations and human or manual operations to ensure the highest degrees of safety and efficiency.

One or more preferred embodiments of the system and method of the present invention include load/unload zones, sometimes referred to herein as WickedHyper Load™. Load/unload zones preferably include an automated system whereby vehicles or pods enter/exit terminal lines. In an automated load/unload zone, shipping containers (e.g., FEUs and TEUs) can be loaded onto/off of pods or vehicles by automated gantries at any terminal end of a transportation line, e.g., a Hyperrail™ transportation line, whether that be an inland location, a port, a rail yard, or a distribution center. Automated Guidance Vehicles (AGVs), or other suitable terminal end transport vehicles, can transport the shipping containers once off-loaded from the transportation line pods or vehicles, and also from the container storage locations to load onto the pods or vehicles on the transportation line. Loading/off-loading phases preferably can be achieved in 20-second to 60-second intervals. The time interval can be increased to accommodate slower flows of containers, as necessary. Gates into/out of loading and other operation zones preferably are controlled by sensors, precluding multiple pods or vehicles from occupying a single location. Sensors that can be used include motion sensors available from TDK.

A gantry that can be used in one or more preferred embodiments of the present invention, preferably is about 2-3 stories high, or 25 to 35 feet (7.62 to 10.67 m) high, and can be a rubber-tired gantry (a RTG) of the type with a crane, or a more stationary gantry, but preferably is capable of lifting about 40 tons (36,287 kg) and can be incorporated into an automated and synchronized system activated by sensors. An automated RTG available from Kone Cranes (see www.konecranes.com) is an example of a gantry that can be used and potentially modified for use in one or more embodiments of the system and method of the present invention. An RTG can be at a semi-fixed location at a terminal end and preferably is automated.

One or more preferred embodiments of the system and method of the present invention includes a marine or inland river port support system for the transportation system, which is sometimes referred to herein as WickedHyper Port™. A port support system of the present invention preferably includes load/unload zones, maintenance zones, potential passenger containers for moving people, and possibly automated shelving systems for ocean-bound and inland-bound containers (or for end terminal inbound or end terminal outbound containers). Preferably existing/developing technology, such as imbedded pavement sensors, installed wires, directional magnetic tapes, lasers, and/or transponders can be used to determine routes for driverless Automated Guidance Vehicles (AGVs) that can be incorporated into one or more embodiments of port support systems of the present invention. Multiple programmed routes—with slight variations—can be utilized to help preclude rutting of pavement that would more quickly occur if fully laden AGVs (e.g., carrying several tons (kilograms), e.g., around 35 to 40 tons (31,751.5 to 36,287 kg) each) retraced the exact same route between two points in the port. Preferably a port support system also makes efficient use of space through reliance upon the on-demand nature of the transportation line and organizational effectiveness of automated shelving systems, alleviating space-consuming stacks of containers throughout a port site. A port support system of the present invention also eliminates the need for a spacious rail yard within the limited confines of the port, freeing up valuable space for profitable growth-intensive purposes. One or more preferred embodiments of the system and method of the present invention include a rail yard system, which is sometimes referred to herein as WickedHyper Rail™. An organizational layout of a rail yard system of the present invention at a rail yard location preferably includes load/unload zones, maintenance zones, buses or passenger containers for moving people and possibly automated shelving systems for inbound and outbound containers, if desired. Preferably a rail yard system integrates existing/developing technology, such as imbedded pavement sensors that determine routes for driverless Automated Guidance Vehicles (AGVs). Multiple programmed routes—with slight variations—are preferably included to help to preclude rutting of pavement that would more quickly occur if fully laden AGVs (e.g., carrying several tons (kilograms), e.g., 35 to 40 tons (31,751.5 to 36,287 kg) each) retraced the exact same route between two points at the rail yard. Preferably a rail yard system also makes efficient use of space through reliance upon the on-demand nature of the transportation line, which enables containers to be pulled from the pores automated shelving system only when the outbound traditional train is ready for loading, as well as off-loading containers from incoming trains directly onto a transportation line for transshipment to a port, or other desired terminal destination.

One or more preferred embodiments of the system and method of the present invention include a hub support system, sometimes referred to herein as WickedHyper Hub™. A hub support system of the present invention can be used at distribution centers, e.g., distribution centers used by big-box retailers. Such distribution centers are optimally located inland from a port, in an area that is less congested and provides a nexus from which further distribution of goods can be efficiently performed. A hub support system preferably includes load/unload zones, maintenance zones, buses or passenger containers for moving people and possibly automated shelving systems, if desired in lieu of warehouses, for inbound and outbound containers. A hub support system of the present invention preferably integrates existing/developing technology, such as imbedded pavement sensors that determine routes for driverless Automated Guidance Vehicles (AGVs). Multiple programmed routes—with slight variations—are preferably included to help preclude rutting of pavement that would more quickly occur if fully laden AGVs (e.g., carrying several tons (kilograms), e.g., 35 to 40 tons (31,751.5 to 36,287 kg) each) retraced the exact same route between two points at the distribution center. Preferably a hub support system makes efficient use of port space by combining the higher speeds of a transportation line of the present invention and RFID-type container tagging, which enable containers to be rapidly moved from the port to a distribution center's outbound warehouse or hub and eliminates stacking of containers at the port. Additionally, the incorporation of a hub support system at distribution centers removes a tremendous amount of short-haul truck traffic from the roads, which greatly lengthens the life of the roadways, reduces the massive carbon footprint, and eases traffic congestion between the port and distribution center. Furthermore, a hub support system of the present invention significantly decreases the need for the extensive truck-gate system traditionally employed by container ports.

One or more preferred embodiments of the system and method of the present invention include a maintenance zone or facility, sometimes referred to herein as WickedHyper Fix™. Preferably a maintenance zone or facility of the present invention enables transportation line vehicles or pods, including individual container vehicles or pods or train vehicles or pods, to be pulled off-line for repairs or routine service without disrupting container transport operations. Preferably a maintenance zone or facility of the present invention extends from the end of a load/unload zone, separated by an additional control gate. Depending upon the electrical power source (e.g., in-line through the transportation line structure or a pod-mounted/vehicle-mounted battery), a maintenance zone or facility can have different configurations or lay-outs based on the need for recharging of pod or vehicle batteries.

In one or more embodiments a maintenance zone or facility does not include recharging capacity. This facility can be smaller, e.g., including three service bays that include lift capability for pods or vehicles, including for individual container vehicles or pods or train vehicles or pods, being worked on. A maintenance zone or facility can include as many bays as desired. Also preferably included in a maintenance zone or facility are critical and routine spare parts to reduce the wait time for repairs; diagnostic tools to quickly identify mechanical, electrical, or electronic problems; and welding equipment to perform on-site metal work as needed.

In one or more embodiments a maintenance zone or facility includes recharging capacity. Such a maintenance zone or facility preferably has additional bays for recharging pod or vehicle batteries, e.g., 1, 2, 3, 4, or more recharging bays with a total of 4, 5, 6, 7 or more total bays. The recharging bays can be placed on either end of the facility and preferably allow for stacking of pods or vehicles, e.g., “double stacking” or “triple-stacking”, of pods or vehicles, including individual container vehicles or pods or train vehicles or pods. The stacking can be done, for example, by means of rails that lower and raise, which can be similar to what is used to load automobiles on a car-carrying truck. Entry/exit of pods or vehicles into/out of the maintenance zone or facility preferably is controlled manually to ensure safe and efficient introduction/extraction. In other embodiments, entry/exit of pods or vehicles into/out of the maintenance zone or facility can be automated or partially automated with some manual or human oversight.

One or more preferred embodiments of the system and method of the present invention include a turntable, sometimes referred to herein as WickedHyper Turn™. Preferably a turntable of the present invention is a mechanism that enables the transportation line to perform turns of any angle, especially when limited by rights-of-way (ROW) whose linear representation features sharp turns. The ROW available between a port and an inland transfer facility must often pass through congested and urbanized geographic areas with little, if any, allowance for wide turns. One or more embodiments of a turntable of the present invention preferably provide a means by which transportation lines may intersect at any angle, connected by the turntable, which can be a trestle-type turntable. Preferably a turntable of the present invention is elevated as a safety measure to prevent at-grade interaction with pedestrians and/or motorists and avoid at-grade dangers. Prior to reaching a turntable, a pod or vehicle, including individual container vehicles or pods, or train vehicles or pods, can be signaled by imbedded transportation line sensors, installed wires, directional magnetic tapes, lasers, and/or transponders, included as part of the overall transportation system or Hyperrail™ system, to decelerate.

A turntable preferably is guarded by entry gates that require the oncoming pod or vehicle to come to a full stop before engaging the turntable or trestle, which preferably has a pair of guide rails built in to match rails of the entering/exiting transportation line. Once engaged, the turntable aligns its built-in rails with mating rails on those of the entering pod or vehicle, opens the gate, signals for the pod or vehicle to enter, stops the pod or vehicle and closes the gate. The turntable then rotates to align its rails with rails of the exit direction, stops, and signals the pod or vehicle to exit. The pod or vehicle can then accelerate to its next destination, whether a terminal or another turntable.

One or more preferred embodiments of the system and method of the present invention include shims, sometimes referred to herein as WickedHyper Shims™. One or more preferred embodiments of a shim of the present invention is a proactive measure in the construction of pylons that support the transportation line structure. Calculating for ground settlement below pylons over a period of time is responsible planning, especially in areas known for less sturdy substrata. Given that the transportation line will have a maximum tolerance relating to such settlement because of the effect it has on the integrity and subsequent operation of the transport line structure, it is preferable to have a pre-planned method for addressing repairs related to settlement rather than having to react with more expensive solutions. Preferably, a shim solution includes a two-piece pylon, with the seam between sections covered by a locking sheath, that can be a wide metal collar, and securing hardware, which makes it sufficient to prevent lateral slippage between the supported pieces. If ground settlement beneath the pylon nears the maximum tolerance allowable for that particular section of the transportation line, a repair team can unlock the sheath and lift the transportation line support structure by using, for example, hydraulic jacks and sturdy beams to push up under the spreading arms of the pylon or a mobile crane to provide lift from above, for example. Once the upper part of the pylon has been lifted to a sufficient height, a pre-made concrete shim of applicable thickness can be placed in the gap, the top portion of the pylon can be set back down, and the metal sheath can be closed and locked. Without a shim of the present invention, the repair would likely involve placement of new, taller pylons to address the ground settlement.

One or more preferred embodiments of the system and method of the present invention include passenger containers, sometimes referred to herein as a bus or as WickedHyper Bus™. Although a transportation line of one or more preferred embodiments of the system or method of the present invention is primarily for transporting container cargo, a passenger container of the present invention can be included in the system and method with the capability to move people between terminals. A passenger container of the present invention preferably includes interior seats and expansive windows; is tall enough to allow passengers to comfortably walk about inside; and can be carried around the terminal by an AGV or other suitable terminal end cargo transportation vehicle. A passenger container preferably has an outer shape that approximates an FEU, or a TEU, including clamp points around the top for the gantries to secure.

A passenger station preferably is located at each terminal as part of a passenger container system, allowing people to embark/debark without the very short time constraints associated with cargo load/unload zones. Once an outgoing passenger container is ready to depart and all passengers are securely restrained, an AGV, or other suitable terminal end cargo transport vehicle, is preferably placed into a departing/on-loading queue by a control tower. From there, the passenger container can be treated just like a cargo container, lifted by a gantry and loaded onto a waiting pod or vehicle, including individual container vehicles or pods or train vehicles or pods, at the transportation line. The gantry preferably lifts the passenger container no higher than necessary to safely move the container between a pod or vehicle and AGV, and sensors can ensure that gantry clamps are secured before lifting, as with shipping containers. Once securely on the pod or vehicle, the passenger container can depart the terminal in accordance with the next loading phase time interval, e.g., a 20-second to 45-second loading phase. Passenger container travel can be simultaneous in both directions or staggered, and the departure intervals are preferably managed by the control tower.

One or more preferred embodiments of the system and method of the present invention include a refrigeration continuation system, sometimes referred to herein as WickedHyper Chill. Preferably a refrigeration system of the present invention ensures that refrigerated shipping containers have access to electrical power during transport on a transportation line or track or Hyperrail™ line or track, if necessary. Refrigerated containers, sometimes referred to herein as reefers, preferably are stored at terminals on reefer racks, which can be metal storage racks designed to hold multiple reefers connected to electrical supply while awaiting transshipment. Once designated to move, the electrical supply preferably is manually disconnected for safety reasons, but disconnection can also be automated if desired. If it is determined that it is allowable for the reefer to travel without access to electrical power, based on the temperature sensitivity of the contents and/or the length of the transshipment time, then the reefer preferably is loaded onto an AGV, or other suitable terminal end cargo transportation vehicle, and is placed into the a load queue by a control tower operator.

If powered refrigeration is needed throughout the transshipment time, a battery pack preferably can be secured to the top of the reefer in a manner that does not interfere with the gantry clamps, and an electrical cable can be extended from the battery pack to the appropriate electrical socket. Once the reefer arrives at its next terminal and has immediate access to a different source of electrical power (e.g., a train or another reefer rack) the battery pack can be disconnected, e.g., manually, and removed from the reefer. In one or more embodiments of the system and method, battery packs preferably are stored and recharged near reefer racks at a port support system, the transportation line and/or at a hub support system.

In one or more preferred embodiments of a cargo transportation system and method of the present invention, a pod or vehicle is provided for about every 20 seconds of a transportation line or track.

In one or more preferred embodiments of a cargo transportation system and method of the present invention, a pod or vehicle is provided for about every 20 to 50 seconds of a transportation line or track.

In one or more preferred embodiments of the present invention an average speed of a pod or vehicle traveling along a transportation line or track is about 75 to 100 mph (33.528 to 44.704 meters per second).

In one or more preferred embodiments of the present invention an average speed of a pod or vehicle traveling along a transportation line or track is about 60 to 200 mph (26.823 to 89.408 meters per second).

In one or more preferred embodiments, a cargo transportation system of the present invention includes 50 vehicles or pods that can carry one to two cargo containers, wherein some of said pods are in use and some of said pods are undergoing maintenance or recharging.

In one or more preferred embodiments, a cargo transportation system of the present invention includes multiple trainsets of vehicles or pods that can each carry, e.g., 10, 18, or 20 cargo containers, wherein some of said pods are in use and some of said pods are undergoing maintenance or recharging. The number of trainsets can be determined by the transient time between terminal locations and the cargo container capacity of the trainset.

In one or more preferred embodiments, a cargo transportation system of the present invention includes a desired amount of pods or vehicles, e.g., between about 10 and 200, and possibly more or less depending on client demands of the system and/or capacity of the system.

In one or more preferred embodiments, a cargo transportation system of the present invention includes 10 to 100 vehicles or pods, wherein some vehicles or pods are in use and some vehicles or pods are undergoing maintenance or recharging.

In one or more preferred embodiments, a cargo transportation system of the present invention includes 180 to 200 vehicles or pods, wherein some vehicles or pods are in use and some vehicles or pods are undergoing maintenance or recharging.

In one or more preferred embodiments, a cargo transportation system of the present invention includes 20 to 120 vehicles or pods, wherein some vehicles or pods are in use and some vehicles pods are undergoing maintenance or recharging.

In one or more preferred embodiments, a cargo transportation system of the present invention includes multi-vehicle trainsets, each consisting of powered end-vehicles and interior cargo vehicles. Such trainsets can be configured to carry, e.g., 10, 18, or 20 FEU cargo containers, with each powered end-vehicle carrying a single FEU container and each interior cargo vehicle carrying two FEU containers.

In one or more preferred embodiments, a cargo transportation system of the present invention includes a desired amount of pods or vehicles such that the system can transport up to 20,160 TEUs per day between a port support system and an inland support system, or between a first desired terminal and a second desired terminal, assuming the system is operating at 70% of maximum capacity.

In one or more preferred embodiments, a cargo transportation system of the present invention includes a desired amount of pods or vehicles such that the system can transport up to about 22,000 shipping containers per day between a port support system and an inland support system, or between a first desired terminal and a second desired terminal, assuming the system is operating at 70% of maximum capacity.

In one or more preferred embodiments, a cargo transportation system of the present invention includes a desired amount of pods or vehicles such that the system can transport about 10,000 to 40,000 shipping containers per day between a port support system and an inland support system, or between a first desired terminal and a second desired terminal, assuming the system is operating at 70% of maximum capacity, e.g., depending on the size of the shipping containers.

In a one or more preferred embodiments a cargo transportation system of the present invention can be adapted to include a desired amount of pods or vehicles such that the system can transport a desired amount of FEUs or TEUs or other sized shipping containers per day between a port support system and an inland support system, or between a first desired terminal and a second desired terminal, depending on client demands on the system and/or desired capacity of the system.

In one or more preferred embodiments, a transfer vehicle at a terminal end can be an AGV and driverless. In other embodiments, a transfer vehicle can be a transfer vehicle that can have a driver that can drive or monitor while transferring containers.

In one or more preferred embodiments, loading/unloading of a pod or vehicle with a shipping container can be performed in 40 seconds to 20 minutes.

In one or more preferred embodiments, loading/unloading of a pod or vehicle with a shipping container can be performed in 40 seconds to 10 minutes.

In one or more preferred embodiments, loading/unloading of a pod or vehicle with a shipping container can be performed in 2 minutes to 10 minutes.

In one or more preferred embodiments, the system of the present invention includes:

i. WickedHyper Load™—a system for on/off-loading of containers from Hyperrail™ transport vehicles or pods, including a switch track, automated cranes with clamp sensors, synchronization software, automated guidance vehicle (AGV) or gondola movement;
ii. WickedHyper Port™—a port configuration for Hyperrail™ cargo terminal, including WickedHyper Load™, inbound/outbound warehouses and/or automated shelving systems, such as BoxBay, freight forwarding control system, WickedHyper Bus™, power plant, maintenance facility (WickedHyper Fix™);
iii. WickedHyper Rail™—a railyard configuration for Hyperrail™ cargo terminal, which includes WickedHyper Load™, WickedHyper Bus™, power plant, WickedHyper Fix™;
iv. WickedHyperHub™—a distribution center configuration for a Hyperrail™ cargo terminal, which includes WickedHyper Load™, WickedHyper Bus™, power plant, WickedHyper Fix™;
v. WickedHyper Turn™—a device enabling cargo Hyperrail™ pods to make sharp turns, which includes trestle/turntable, control software, power station;
vi. WickedHyper Fix™—a maintenance facility for Hyperrail™ transport pods or vehicles, which preferably includes a system of exit/entry, critical parts storage, diagnostics, indoor repair structure, and can also include charging stations when pods are battery-operated, wherein the exit/entry system can be an extension of the switch track at the end of the WickedHyper Load™ system, and wherein rather than returning to be uploaded, the pod or vehicle can instead be directed to continue through to the maintenance/recharging facility.
vii. WickedHyper Bus™—a passenger movement system on the container cargo line, including a passenger station at each terminal;
viii. WickedHyper Chill™—a system for handling refrigerated/frozen cargo, including placement of reefer racks, possible automated or manual system for electrical hookup on Hyperrail™ pods, and wherein the system assesses need for power hookup based on contents, allowable temperature variance, and length of time; and
ix. WickedHyperShim™—a Hyperrail™ support column assembly design that foresees ground settlement and allows for adjustment (shim insertion) rather than column replacement.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a partial perspective view of a preferred embodiment of a container transportation system and method of the present invention;

FIG. 2 is a schematic diagram showing a preferred embodiment of a load/unload zone in a preferred embodiment of a container transportation system and method of the present invention;

FIG. 3 includes steps in a preferred embodiment of a method at a load/unload zone as shown in FIG. 2;

FIG. 4 is a partial perspective view showing a preferred embodiment of a load/unload zone in a preferred embodiment of a container transportation system and method of the present invention;

FIG. 5 is a schematic diagram showing a preferred embodiment of a load/unload zone at a port in a preferred embodiment of a container transportation system and method of the present invention;

FIG. 6 is a schematic diagram showing a preferred embodiment of a load/unload zone at a rail yard in a preferred embodiment of a container transportation system and method of the present invention;

FIG. 7 is a schematic diagram showing a preferred embodiment of a load/unload zone at a distribution hub in a preferred embodiment of a container transportation system and method of the present invention;

FIG. 8 is a schematic diagram showing a first preferred embodiment of a maintenance facility in a preferred embodiment of a container transportation system and method of the present invention;

FIG. 9 is a perspective view of the first preferred embodiment of a maintenance facility of the present invention;

FIG. 10 is a schematic diagram showing a second preferred embodiment of a maintenance facility of the present invention;

FIG. 11 is a perspective view of the second preferred embodiment of a maintenance facility of the present invention;

FIG. 12 is a partial top view showing a preferred embodiment of a turntable of the present invention;

FIG. 13 is perspective view showing a preferred embodiment of a turntable of the present invention;

FIG. 14 is an exploded view of a preferred embodiment of a shim system of the present invention;

FIG. 15 is a front view of a preferred embodiment of a passenger station and passenger container in a preferred embodiment of a container transportation system and method of the present invention;

FIG. 16 is a perspective view of a preferred embodiment of a refrigerated container of the present invention;

FIG. 17 is a perspective view of a preferred embodiment of a load/unload zone in a preferred embodiment of a container transportation system and method of the present invention that utilizes train pods or vehicles that can transport a plurality of cargo containers;

FIG. 18 is a perspective view of a preferred embodiment of a load/unload zone in a preferred embodiment of a container transportation system and method of the present invention that utilizes train pods or vehicles that can transport a plurality of cargo containers;

FIG. 19 is a perspective view of a preferred embodiment of a load/unload zone in a preferred embodiment of a container transportation system and method of the present invention that utilizes train pods or vehicles that can transport a plurality of cargo containers;

FIG. 20 is a top view of a schematic diagram illustrating a preferred embodiment of load/unload zone and a maintenance facility/passenger station at a port of a preferred embodiment of a container transportation system and method of the present invention that utilizes train pods or vehicles that can transport a plurality of cargo containers;

FIG. 21 is a perspective view illustrating a preferred embodiment of a load/unload zone and a maintenance facility/passenger station at a terminal end of a preferred embodiment of a container transportation system and method of the present invention that utilizes pods or vehicles that can transport two to four cargo containers;

FIG. 22 is a perspective view illustrating a preferred embodiment of a load/unload zone and a maintenance facility/passenger station at a terminal end of a preferred embodiment of a container transportation system and method of the present invention that utilizes pods or vehicles that can transport one to two cargo containers;

FIG. 23 is a chart including data on rate/capacity/cycle time/cycle phases for preferred embodiments of a container transportation system and method of the present invention that utilize pods or vehicles that can transport one cargo container;

FIG. 24 is a chart including data on rate/capacity/cycle time/cycle phases for preferred embodiments of a container transportation system and method of the present invention that utilize pods or vehicles that can transport two cargo containers or ten cargo containers;

FIG. 25 is a schematic diagram illustrating another preferred embodiment of a container transportation system and method of the present invention at a preferred embodiment of a port terminal;

FIGS. 26-31 illustrate stages in a preferred embodiment of the method at a port terminal as shown in FIG. 25; and

FIGS. 32A and 32B are charts listing stages in the method as shown in FIGS. 26-31.

### DETAILED DESCRIPTION OF THE INVENTION

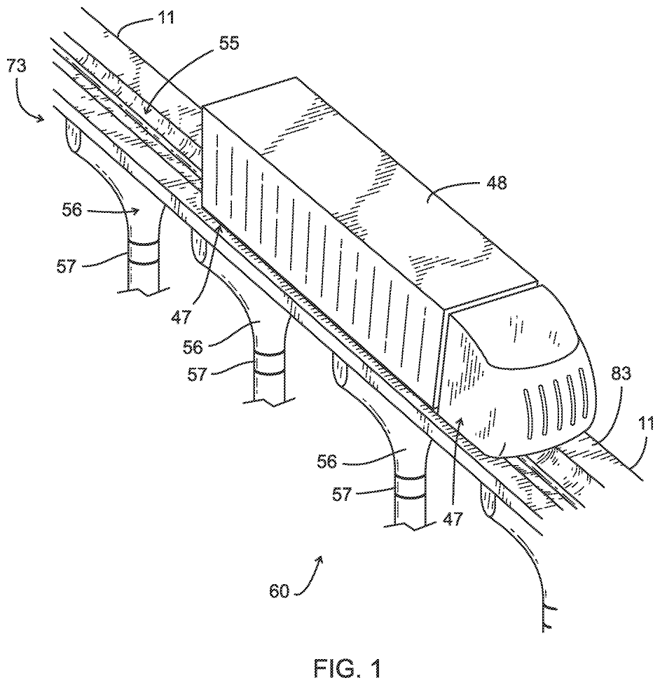

FIGS. 1-32B illustrate various preferred embodiments of the present invention, or charts relating thereto, for transportation systems and methods for transporting, storing, and maintaining shipping containers, passenger containers, and shipping/passenger container vehicles.

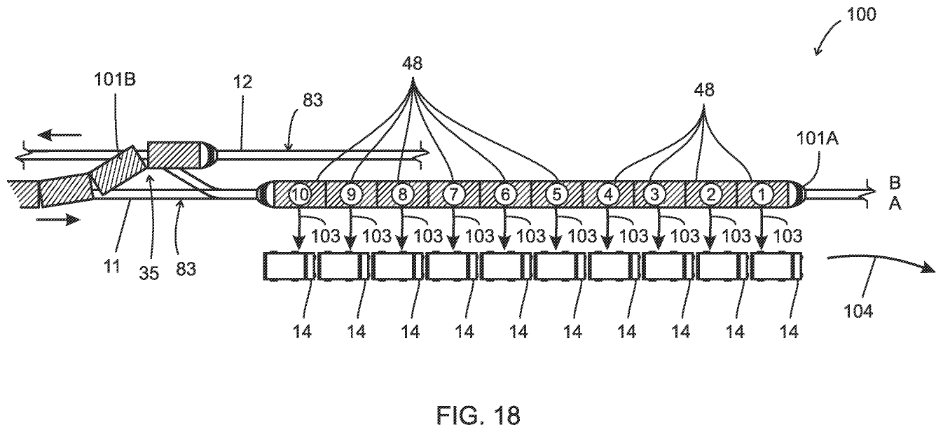

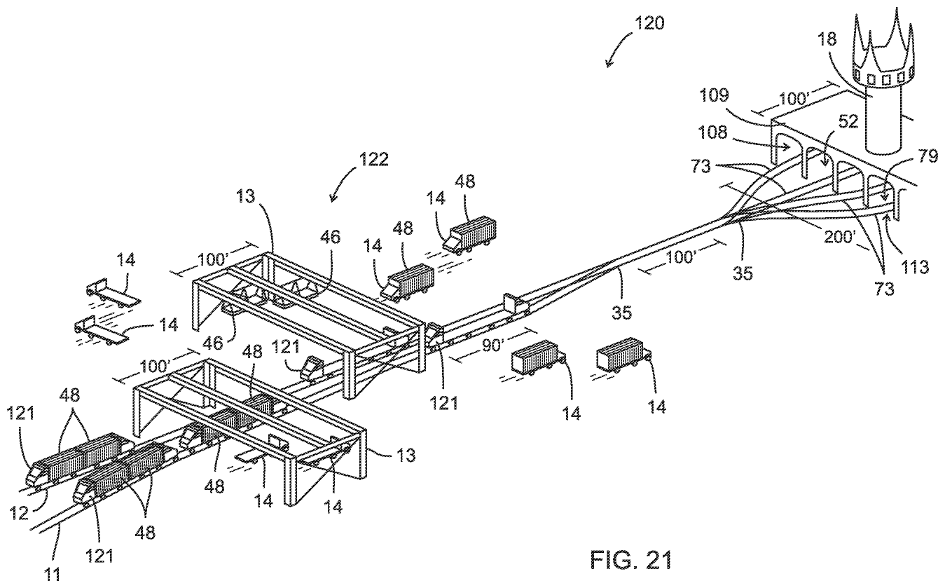

In the various preferred embodiments, the size of the pods or vehicles for traveling along a transportation line 83 can be different. For example, in FIGS. 1-16, 22 a first preferred embodiment of a pod or vehicle 47 that can travel on a transportation line 83 that can carry 1 to 2 cargo containers, (e.g., 1 FEU or 1 to 2 TEUs) is illustrated. In FIGS. 18-20 and 25-31 a second preferred embodiment of a pod or vehicle or trainset 101 that can travel on a transportation line 83 is illustrated that can carry a plurality of cargo containers, e.g., 1 to 40 containers, e.g., 10 to 20 FEUs or 10 to 40 TEUs). In FIG. 21, a third preferred embodiment of a pod or vehicle 121 that can travel on a transportation line 83 is illustrated that can carry 2 to 4 cargo containers, e.g., 2 FEUs or 2 to 4 TEUs). Pods or vehicles 47, 101, 121, can be included in various embodiments of the system and method and terminal ends as described and shown herein in th figures.

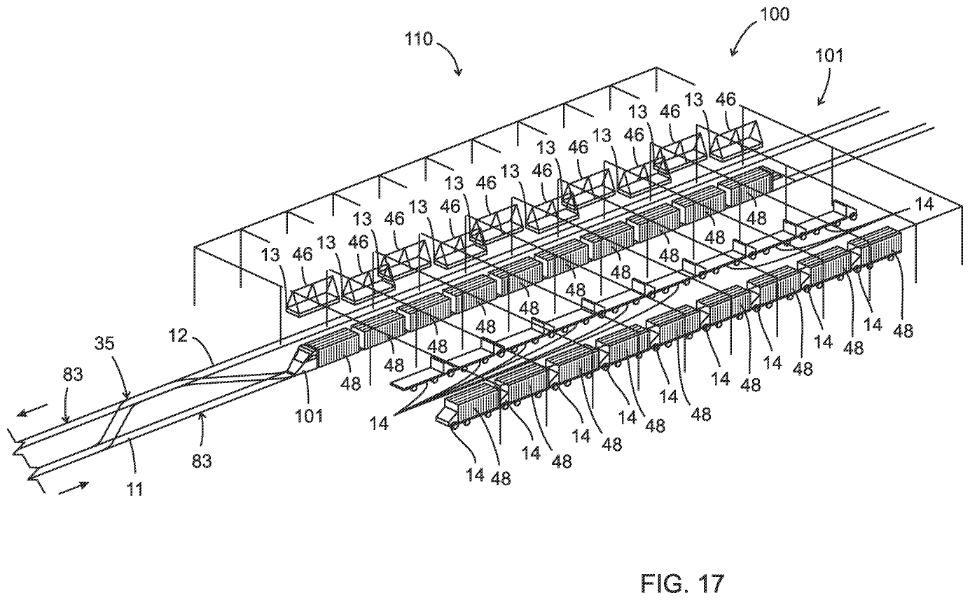

FIGS. 1-16, 22 illustrate embodiments that utilize pods or vehicles for traveling on a transportation line that can carry 1 to 2 cargo containers (e.g., 1 FEU or 1 to 2 TEUs). FIGS. 17-20, 25-31 illustrate embodiments that utilize pods or vehicles for traveling on a transportation line that can carry multiple cargo containers, e.g., 10 to 40 cargo containers (e.g., 10 to 20 FEUs or 10 to 40 TEUs), which are sometimes referred to herein as trainsets, train vehicles or train pods. FIG. 21 illustrates embodiments that utilize pods or vehicles for traveling on a transportation line that can carry 2 to 4 cargo containers, (e.g., 2 FEUs or 2 to 4 TEUs).

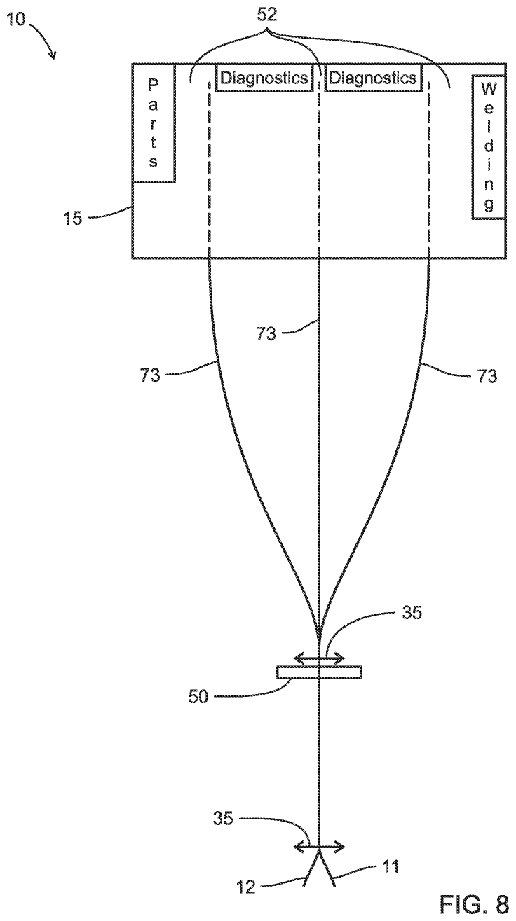

FIGS. 8-11 illustrate maintenance zones at a terminal end that can be used in one or more preferred embodiments of the present invention. Although these figures illustrate pods or vehicles 47 that can carry one cargo container, it should be understood that the maintenance zones can be adapted for use with pods or vehicles 101, 121 that can carry more than one cargo container. Such maintenance zones can be adapted for use with pods or vehicles that can carry 2, 3, 4, 5, 6, 7, 8, 9, 10 or more cargo containers, as desired. A pod or vehicle 47, 101, 121 can be driver or driverless, automated, and/or electric.

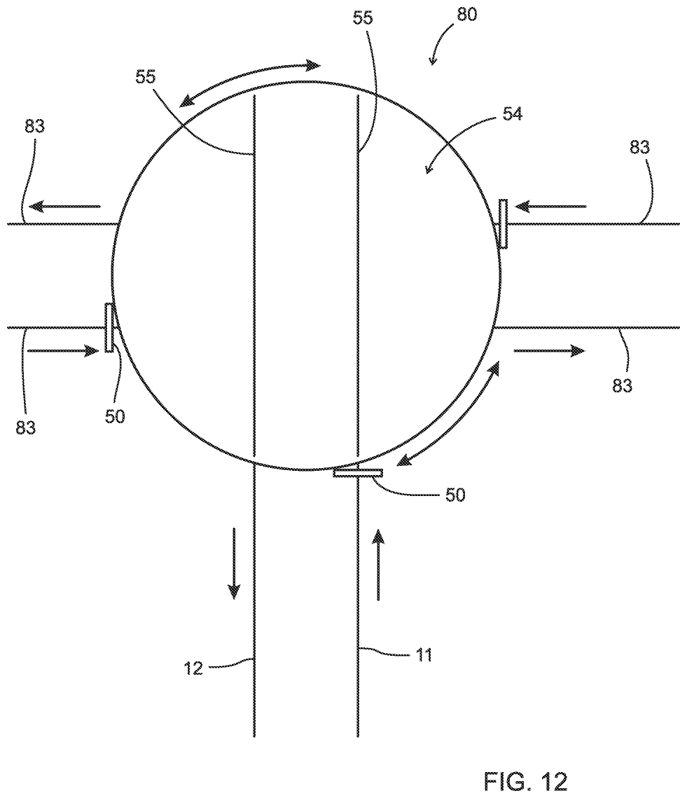

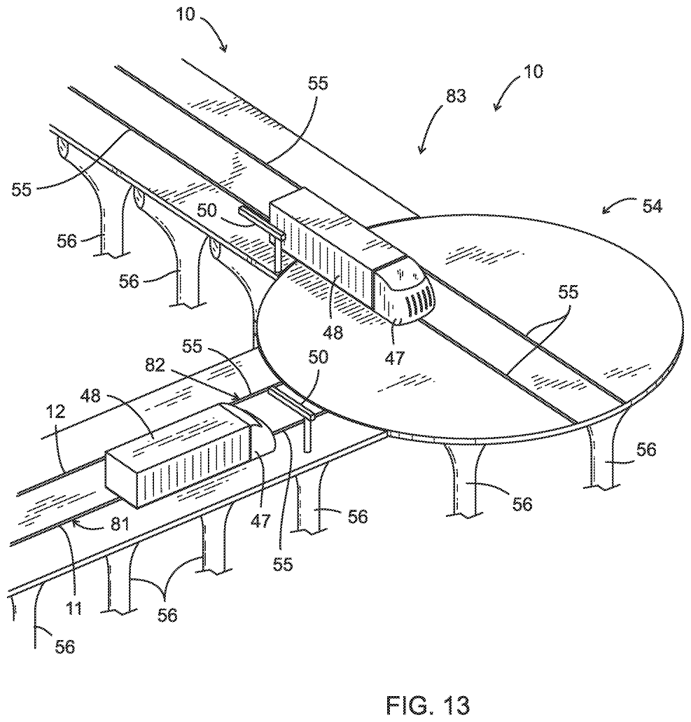

FIGS. 12-13 illustrate a turntable/turn/WickedHyper Turn™ 80 that can be used in one or more preferred embodiments of the present invention. Although FIG. 13 illustrates pods or vehicles 47 that can carry one cargo container, it should be understood that the turntable can be adapted for use with pods or vehicles 101, 121 that can carry more than one cargo container. Such turntables can be adapted for use with pods or vehicles that can carry 2, 3, 4, 5, 6, 7, 8, 9, 10 or more cargo containers, as desired.

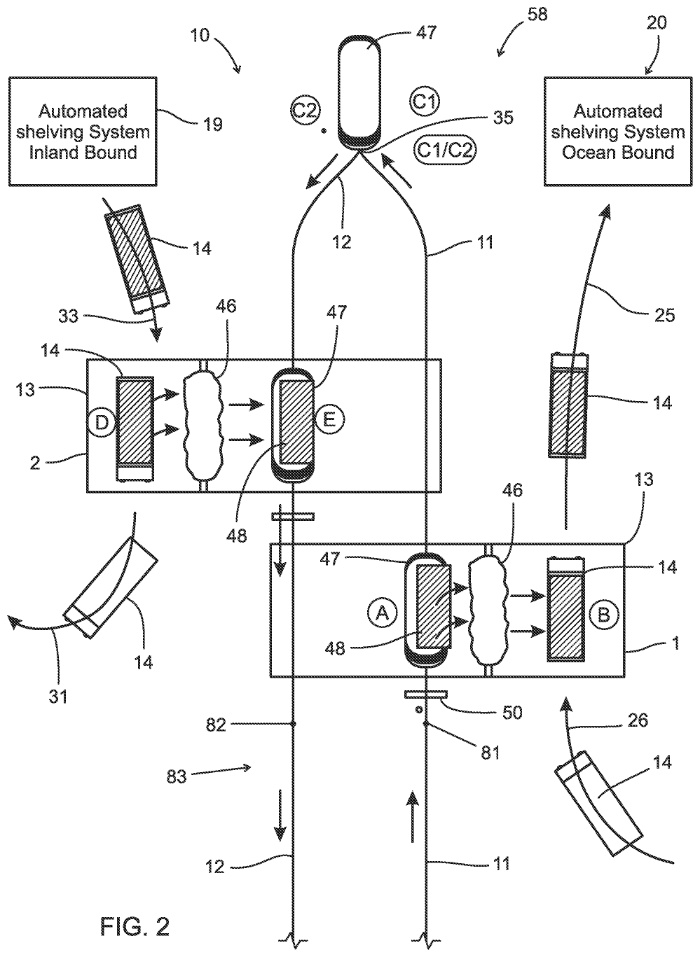

“Hyperrail™” is used herein and in the drawings with regard to a transportation mode and system that combines some of the emerging technologies of hyperloop with those of both monorail and traditional rail, reflected in an on-demand movement of individual vehicles or pods 47 (see, e.g., FIGS. 1-2), vehicles or pods 101 (see, e.g., FIGS. 17-20), or vehicle or pods 121 (see, e.g., FIG. 21) along a dedicated transportation line 83, which can be a track as depicted in FIG. 1. A transportation line 83 can also be a monorail, maglev line, grooved pathway, roadway, or traditional rail tracks. Preferably a pod or vehicle 47, 101, 121 is electrically powered (environmentally friendly), and may be propelled by magnetic levitation, linear electric propulsion, or other desired means (which could include wheeled movement).

A pod or vehicle 47 preferably is designed to carry fully-loaded shipping containers 48, e.g., a standard FEU (40-Forty foot (12.19 m) Equivalent Unit) or two TEUs (20-Twenty foot (6.096 m) Equivalent Units) per vehicle or pod 47, the total which can weigh around 35 tons (31,751.5 kg), for example, and including the capacity to transport refrigerated units. A shipping container 48 can be secured in vehicle or pod 47 with fitted recesses that hold the container firmly, for example. A shipping container 48, e.g., a 30-ton (27,215.5 kg) container, sitting in a recessed fitting is very secure.

A trainset pod or vehicle 101 preferably is designed to carry 10 fully-loaded shipping containers 48, e.g., 10 standard FEUs (40-Forty foot (12.19 m) Equivalent Unit) or twenty standard TEUs (20-Twenty foot (6.096 m) Equivalent Units) per trainset vehicle or pod 101, the total which can weigh around 350 tons (317,515 kg), for example, and including the capacity to transport refrigerated units. A shipping container 48 can be secured in a trainset vehicle or pod 101 with fitted recesses that hold the container firmly, for example.

A pod or vehicle 121 preferably is designed to carry 2 fully-loaded shipping containers 48, e.g., 2 standard FEUs (40-Forty foot (12.19 m) Equivalent Unit) or 4 standard TEUs (20-Twenty foot (6.096 m) Equivalent Units) per vehicle or pod 121, the total which can weigh around 70 tons (63,502.9 kg), for example, and including the capacity to transport refrigerated units. A shipping container 48 can be secured in a vehicle or pod 121 with fitted recesses that hold the container firmly, for example.

Although trainsets, pods or vehicles that can carry 1 FEU/2TEUs, 2 FEUs/4TEUs, or 10 FEUs/20TEUs are shown in the figures, it should be understood that a trainset, pod or vehicle can be used in one or more preferred embodiments of the present invention that can carry other desired numbers of shipping containers, e.g., trainsets, pods or vehicles that can carry 1, 2, 3, 4, 5, 6, 7, 8, 9, 10, 11, 12, 13,14, 15, 16, 17, 18, 19, 20 or more as desired can be used in one or more preferred embodiments. It should also be understood that containers of other sizes than a standard FEU or TEU can also be used in the various embodiments of the present invention. Preferably a multiple-container trainset, pod or vehicle is of a size that still allows terminal ends to have a smaller footprint than what is required for a full-size traditional train that can be over one mile long (1.609 kilometer (km)), for example. Preferably a terminal end can have a footprint of 4 to 6 acres (16,187.4 to 24, 281.1 square m).

A trainset, vehicle or pod 47, 101, 121 is preferably automated and equipped with driverless technology that can be controlled by an operations tower or control tower 18 that can incorporate digital freight-forwarding software that can “call” shipping containers (e.g., tagged by RFID or similar identification methods) forward to be moved from one terminal of the transportation line to another terminal, e.g., at a remote location, e.g., 200 miles (321.87 km) away. Preferably a trainset, pod or vehicle 47, 101, 121 is electric and can be propelled along a transportation line 83 via magnetic levitation, linear propulsion, or wheeled movement. A trainset, vehicle or pod 47, 101, 121 can also be adapted for full or part operational control by a driver in a trainset, vehicle or pod 47, 101, 121.

A transportation line 83 can be of the type as shown in FIG. 1 including a plurality of pylons 56 for supporting a guide line, which can be a track. A guide line or track 55 can include a propulsion system, e.g., a magnetic levitation and linear propulsion system of the type used in hyperloop technology or maglev trains (e.g., the Shanghai Transrapid), or a wheeled track guide system, such as used with traditional rail or streetcars. A transportation line 83 can be a single line or can include one or more inbound lines 11 or outbound lines 12 as desired. A transportation line 83 can connect two terminal ends/terminal stations 10, 100, 120 or 130.

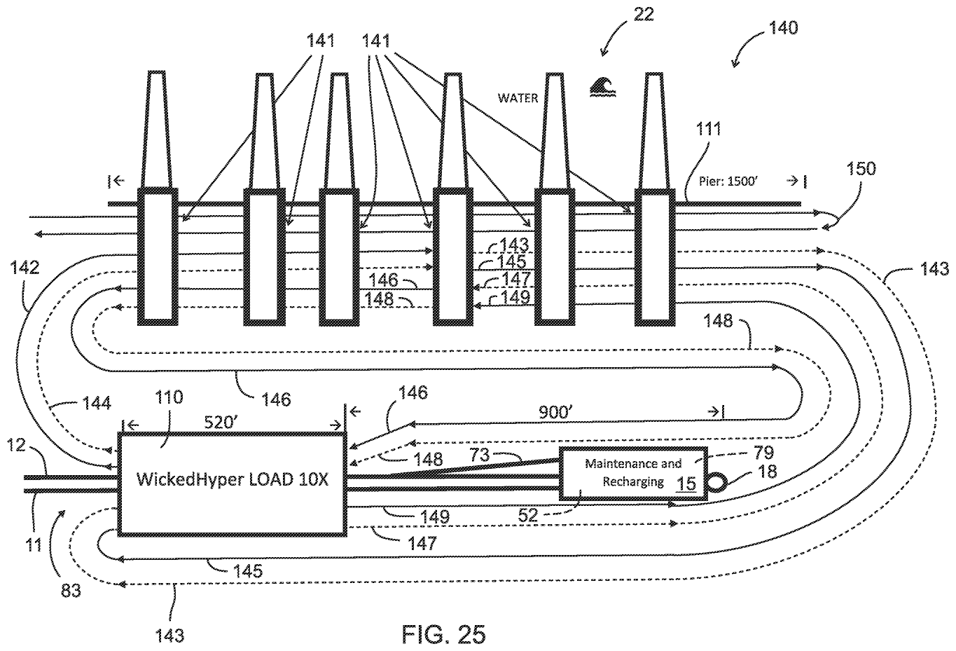

Preferably in one or more embodiments of the system and method of the present invention trainsets, pods or vehicles 47, 101, 121 are dispatched as rapidly as needed from a control tower 18. One rate-determining factor for dispatch rates will be the speed at which shipping containers can be loaded/off-loaded at each end or terminal of a transportation line 83. Dispatch rates are also influenced by the number and speed of crane systems available in a load/unload zone, including ship-to-shore cranes 141 (see FIG. 25).

In a preferred embodiment of a container system and method of the present invention, one pod or vehicle 47 can be dispatched in each direction (e.g., for a two-track system) about every 20 seconds. If a pod or vehicle 47 is dispatched in each direction every 20 seconds, this enables a total movement of 6.3 million TEU shipping containers, annually, assuming 24-hour/365-day operation. Comparatively, it would require 36 double-stacked 120-car trains per day to achieve the same volume over a 365-day period.

In embodiments of the system and method of the present invention including a series of individual vehicles or pods 47 or 121, rather than long trains of connected freight cars, the space requirements to load/unload the pods or vehicles 47 or 121 is a fraction of that needed for a lengthy rail segment of the prior art, when a train is used to move cargo containers from a port to an inland location for example. A terminal end that uses pods or vehicles 47, 121 can have a footprint of about 3 to 5 acres (12,140.6 to 20,234.3 square m). A 120-car train, for example can be more than a mile (1.609 km) long and a port incorporating a rail yard can require 20 to 40 acres (80,937 to 161,874 square m), depending on the number of track sidings. The trucking component that would be needed to transport an equivalent amount of cargo—about 8,640 trucks every day of the year—also presents significant stresses on limited port resources, especially the requirement for port gates, road wear and tear, and traffic management both in and around the port. The carbon footprint of such truck traffic is detrimental to the environment.

When trainset vehicles or pods 101 are used that can carry more than 2 FEUs, e.g., 10 FEU cargo containers, for example, a terminal end can be larger than what is needed with pods 47 or 121, but the footprint is still much smaller than what is needed for a 120-car traditional railway train. A terminal end that uses trainset pods or vehicles 101 that can carry 10 to 20 FEUs can have a footprint of about 4 to 6 acres (16,187.4 to 24, 281.1 square m). A terminal end that uses trainset pods or vehicles 101 that can carry 10 to 20 FEUs can also have a footprint of about 3.8 to 6 acres (15,378.1 to 24,281.1 square m). It is also possible that a terminal end that uses trainset pods or vehicles 101 that can carry 10 to 20 FEUs with 10 to 20 container wagons or wells can also have a footprint of about to 3 to 6 acres (12,140.6 to 24,281.1 square m).

In one or more preferred embodiments, the system and method of the present invention includes various elements beyond the actual propulsion system, track, electrical source, vehicle, and point-to-point vehicle controls (i.e., acceleration/deceleration, braking). In one or more preferred embodiments, the system and method include: (1) a first terminal facility with a land area of about 3 to 6 acres (12,140.6 to 24,281.1 square m). Having a load/unload zone, a maintenance zone, a recharge zone, a refrigeration zone, a storage zone, and a passenger zone; (2) a second terminal facility with a land area of about 3 to 6 acres (12,140.6 to 24,281.1 square m) having a load/unload zone, a maintenance zone, a recharge zone, a refrigeration zone, a storage zone, and a passenger zone; (3) a transportation line extending between the first terminal facility and the second terminal facility on which vehicles carrying passenger or cargo containers can be transported to or from the first and second terminal facilities. In one or more embodiments a vehicle with a passenger container can be on the transportation line at the same time as another vehicle with a cargo container. In these embodiments, pods or vehicles 47, 121 can be utilized in the system and method, or pods or vehicles that can carry 1 to 2 FEU cargo containers.

In one or more preferred embodiments, the system and method of the present invention includes various elements beyond the actual propulsion system, track, electrical source, vehicle, and point-to-point vehicle controls (i.e., acceleration/deceleration, braking). In one or more preferred embodiments the system and method include: (1) a first terminal facility with a land area of about 3.8 to 6 acres (15,378.1 to 24,281.1 square m) having a load/unload zone, a maintenance zone, a recharge zone, a refrigeration zone, a storage zone, and a passenger zone; (2) a second terminal facility with a land area of about 3.8 to 6 acres (15,378.1 to 24,281.1 square m) having a load/unload zone, a maintenance zone, a recharge zone, a refrigeration zone, a storage zone, and a passenger zone; (3) a transportation line extending between the first terminal facility and the second terminal facility on which vehicles carrying passenger or cargo containers can be transported to or from the first and second terminal facilities. In one or more embodiments, a vehicle with a passenger container can be on the transportation line at the same time as another vehicle with a cargo container. In these embodiments, trainsets, pods or vehicles 47, 101, and 121 can be utilized in the system and method.

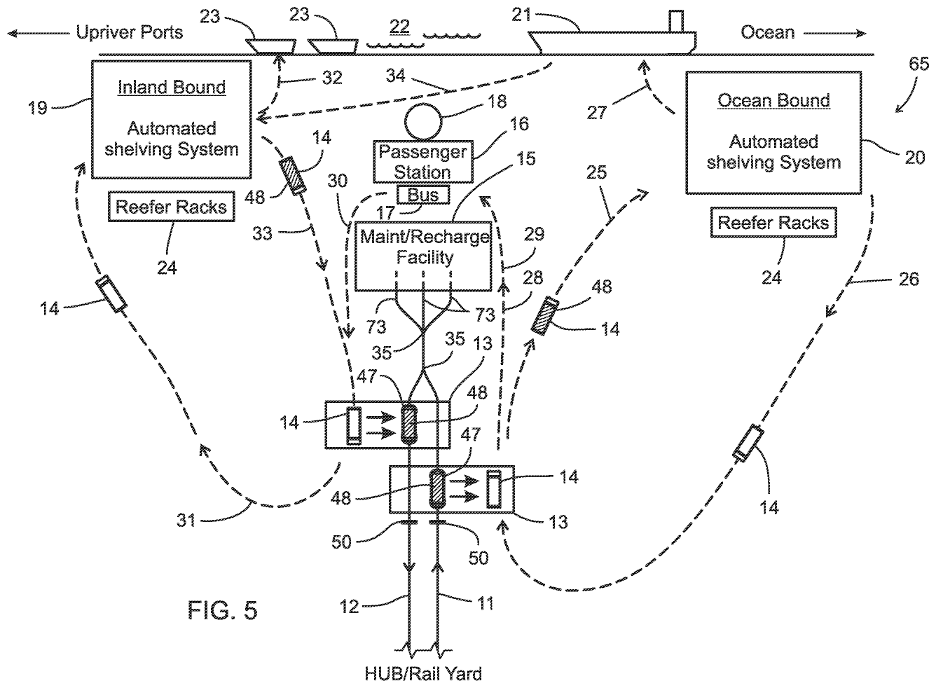

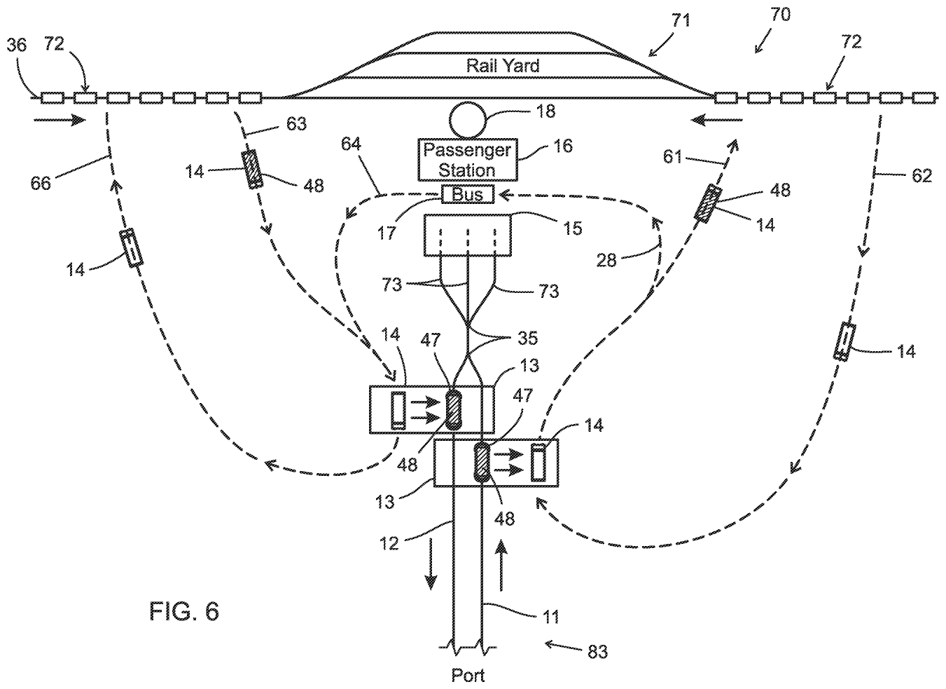

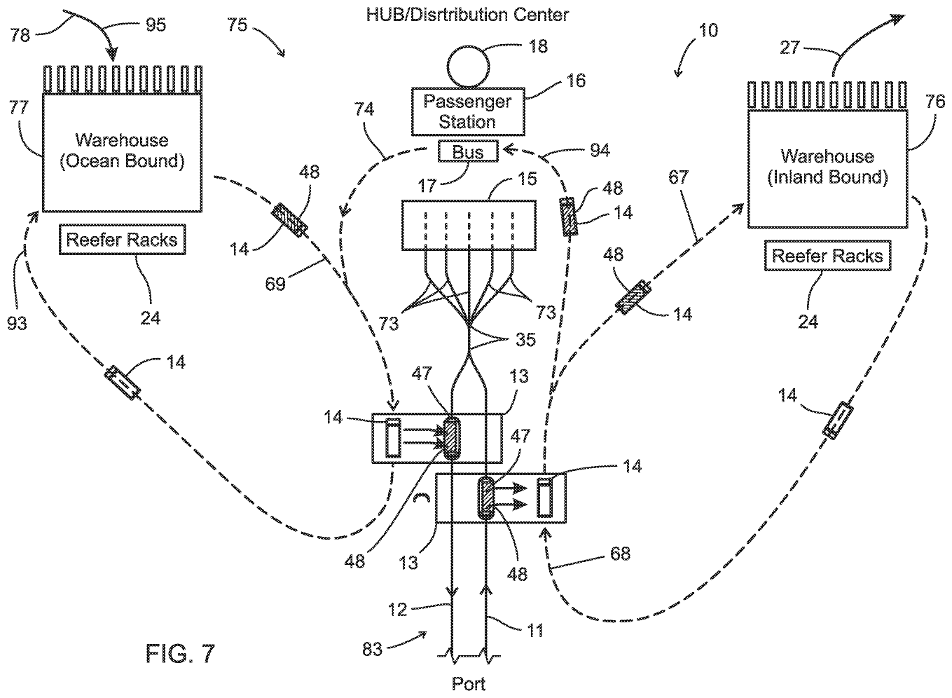

A preferred embodiment of load/unload zone 58 for a transportation system and method utilizing pods or vehicles 47 is depicted in FIG. 2, which can be provided at a transportation line terminal facility station or terminal end 10, e.g., which can be at a port support system 65 as shown in FIG. 5, at a rail yard support system 70 as shown in FIG. 6, or at a hub support system 75 as shown in FIG. 7. A load/unload zone 58 includes an inbound line 11 and an outbound line 12 as part of transportation line 83. Inbound line 11 and outbound line 12 can converge at a switch 35 at which a pod 47 on inbound line 11 can be moved to outbound line 12, for example.

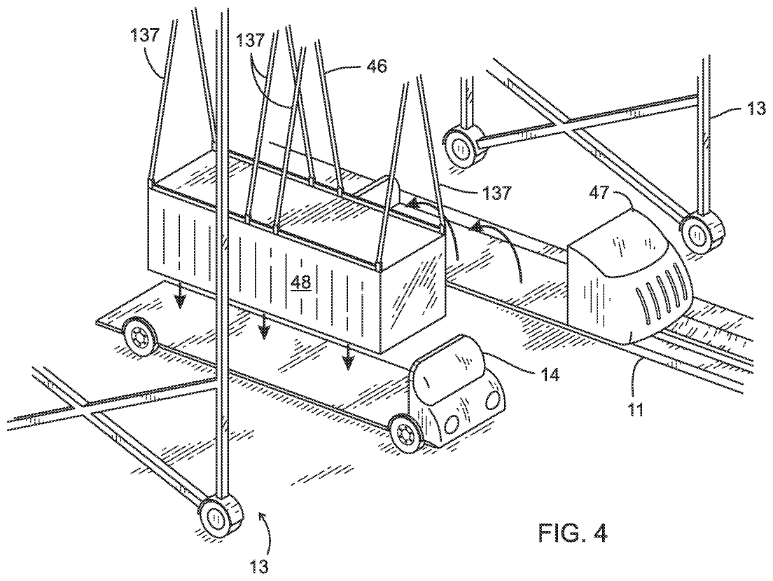

A pod 47 traveling on line 11 carrying a cargo container 48 can be unloaded at a loading dock which can include a gantry 13 set up at inbound line 11, which preferably is automated. A close-up, partial view of a gantry 13 is shown in FIG. 4. A gantry 13 preferably is automated and can have rubber tires, e.g., of the type available from Kone Cranes. Crane 46 of gantry 13 can move cargo container 48 from pod 47 to an Automated Guidance Vehicle (AGV) 14, which is preferably automated and driverless. AGV 14 can be programmed to automatically carry cargo container 48 directly to a ship-to-shore crane 141 for loading onto a ship, or to a shelving system 20, which can be a first shelving system in the load/unload zone 58, and which preferably is also automated, or to a designated container storage area. In other embodiments, other suitable cargo transportation vehicles can be used if desired for onsite movement of transportation containers, e.g., trucks, although AGVs are preferred given their lower environmental impact and that they do not require drivers. Said cargo container 48 can be stored in shelving system 20, which can be an outbound shelving system, until it is ready to be loaded on a departing ship, barge, truck, or train, etc. for moving to an end destination. An AGV 14 can also be automatically programmed to carry a cargo container 48 selected from shelving system 20 to a departing ship or barge or truck or train, etc. An empty pod 47 that was unloaded on inbound line 11 can be advanced to a switch 35 where said pod 47 can then move to outbound line 12 and/or move along another line 73, e.g., to a maintenance facility 15 as shown in FIGS. 5, 6, 7. A maintenance facility can include solar panels 53, for example, if desired.

An empty pod 47 on outbound line 12 can be loaded with a desired cargo container 48 at another loading dock having a gantry 13 set up for an outbound line 12. A desired cargo container 48 can be removed from automated shelving system 19, which can be an inbound shelving system, loaded onto an AGV 14, and automatically advanced to gantry 13 at outbound line 12 via a crane 46. After said cargo container 48 is loaded on outbound line 12, pod 47 can be automatically advanced on outbound line 12 to another transportation terminal. The automated shelving system is preferably digitally connected to software that controls the freight-forwarding system and the control tower can dictate which containers to remove from the automated shelving system.

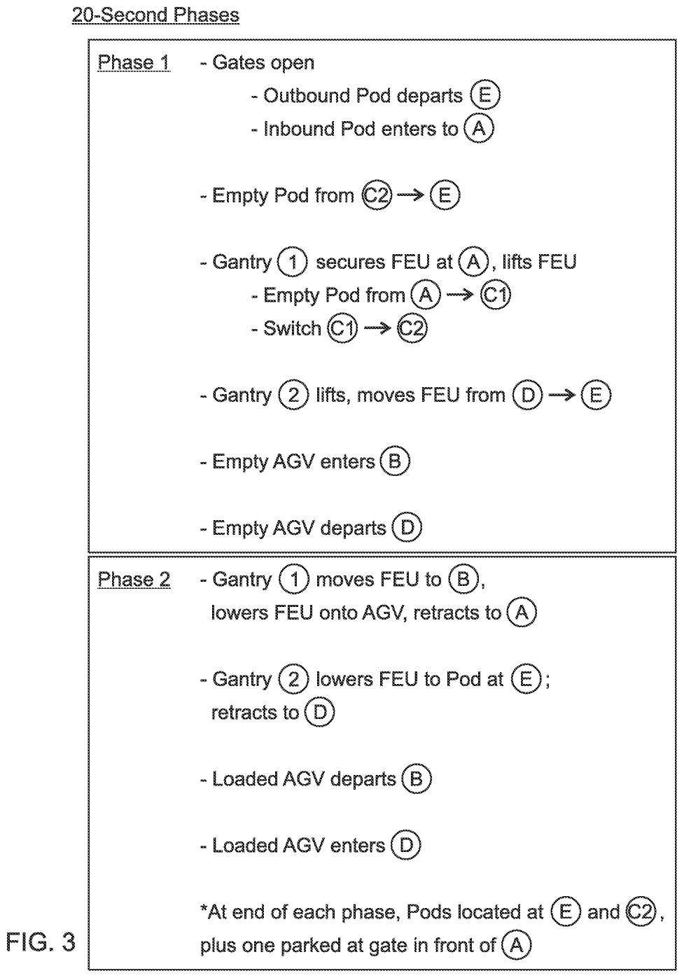

A gate 50 preferably is provided before and/or after a gantry 13. A gate 50 can also be provided at switch 35 locations. Sensors 81 can be included in an inbound line 11 and outbound line 12 prior to a gate 50. When a pod 47 passes over a sensor 81, it can be programmed to brake and/or stop and/or accelerate depending on the signal received from the sensor. A pod 47 can be programmed to automatically slow down/stop prior to a gate 50 when a gate 50 is closed based on a signal received from a sensor 81 in line 11 or 12. A pod or vehicle 47 can also be programmed to accelerate when a gate opens based on a signal received from a sensor 82 in line 11 or 12. FIG. 3 includes steps in 20-second phases that can be included at a load/unload zone 58, and/or at a port support system 65 as shown in FIG. 5, at a rail yard support system 70 as shown in FIG. 6, or at a hub support system 75 as shown in FIG. 7. FIGS. 5, 6, 7 illustrate terminal systems that include maintenance/recharge facilities 15, which pods 47 can enter after being unloaded at gantry 13 on inbound line 11. A transportation system or method using trainsets or pods 101 and 121 can also include similar maintenance/recharge facilities 15 adapted to accommodate the larger trainsets, vehicles or pods 101 or 121.

Twenty second Phases for the method of FIG. 3 can include the following.

Phase 1—Gates open
Outbound Pod departs at E
Inbound Pod enters to A
Empty Pod from C2 to E
Gantry 1 secures FEU at A, lifts FEU
Empty Pod from A to C1
Switch C1 to C2
Gantry 2 lifts, moves FEU from D to E
Empty AGV enters B
Empty AGV departs D

Phase 2
Gantry 1 moves FEU to B, lowers FEU onto AGV, retracts to A
Gantry 2 lowers FEU to Pod at E; retracts to D
Loaded AGV departs B
Loaded AGV enters D
At end of each phase, Pods are located at E and C2, plus one parked at gate in front of A.

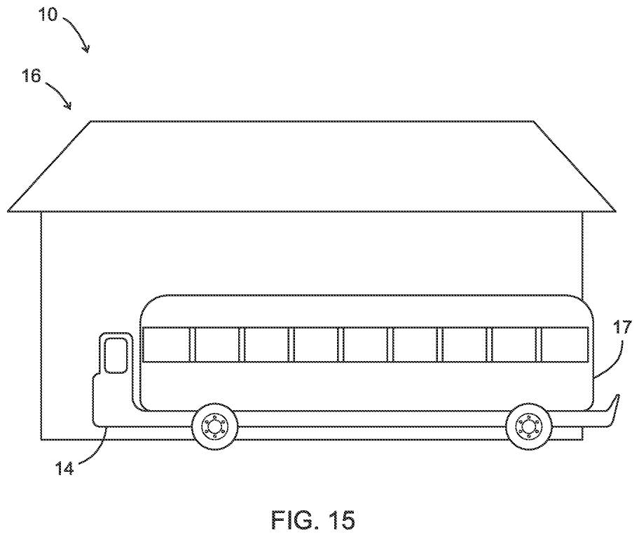

A passenger container or bus 17 can also be placed on an AGV 14 and automatically moved to a passenger station 16. FIG. 15 depicts a close-up view of a passenger station 16 and passenger container or bus 17 on AGV 14. A passenger container or bus 17 can be loaded onto an AGV 14 and passengers can walk into the passenger container or bus 17 on AGV 14. After all passengers are seated and securely restrained, AGV 14 can then be directed, e.g., from the control tower, to bring passenger container or bus 17 to gantry 13 positioned at outbound line 12 where the passenger container or bus 17 can be lifted and moved by crane 46 to an empty pod or vehicle 49 on line 12, which can then transport the passenger container or bus 17 to another transportation terminal. In a transportation system or method using trainsets or pods 101 and 121 more than one passenger container or bus 17 can also potentially be used with a larger pod 101 or 121 on transportation line 83.

A control tower 18 can be included near a passenger station 16, or at another desired location at the terminal facility. A control tower 18 can be manned with personnel to send instructions to a pod 47, AGV 14, gate 50, and/or automated shelving system 19 or 20, which can be included as part of the software controlling a pod 47, AGV 14, gate 50 and/or shelving system 19, 20.

FIG. 5 depicts a preferred embodiment of a terminal facility that is a port support system 65 at which cargo containers 48 on inbound line 11 are ocean bound. A cargo container 48 from a pod 47 on line 11 can be moved to an AGV 14 at gantry 13 and then in the direction of arrows/line 25 to a shelving system 20 that is loaded with ocean bound cargo. Cargo container 48 can be moved on a pod 47 in the direction of arrow 27 to a ship 21, for example. An empty AGV 14 can move from shelving system 20 in the direction of arrow/line 26 back to gantry 13 at inbound line 11, where it can receive another container 48.

An AGV 14 can also move from gantry 13 at inbound line 11 in the direction of arrow/line 29 to a maintenance/recharge facility 15 or to a passenger station 16. A passenger bus 17 can be loaded onto an empty AGV 14 at passenger station 16. A passenger bus can be the same or similar to the sizing of a FEU or TEU, or another desired size.

From passenger station 16 an AGV 14 can move in the direction of arrow/line 30 to gantry 13 on outbound line 12. At gantry 13 at outbound line 12, a container 48 or passenger bus 17 can be loaded onto a pod or vehicle 47 on outbound line 12. From gantry 13 at outbound line 12, an empty AGV 14 can move in the direction of arrow 31 to shelving system 19, which can be an inland bound shelving system, for example, and pick up a cargo container 48 which can then be moved in the direction of arrow 33 to gantry 13 at outbound line 12 for loading on a pod 47 on outbound line 12. Cargo containers 48 can be moved on AGVs 14 from ships/barges 21, 23 on a river or body of water 22 to shelving system 19, e.g., in the direction of line 34, for example, for subsequent movement to pods 47 on outbound line 12. If desired, an AGV 14 carrying a container 48 received from automated shelving system 19 can also be delivered to a ship 21 or 23, e.g., via line 32 for example. Automated shelving systems 19, 20 can also be warehouses or other storage facilities if desired.

The lines and/or routes of travel depicted in FIG. 5 are examples. Multiple different lanes of travel or routes of AGVs 14 are preferably provided/programmed to help prevent erosion.

FIG. 6 depicts a preferred embodiment of a terminal facility that is a rail yard support system 70, which is similar to port support system 65, except cargo containers on inbound line 11 are train 72 bound instead of ocean or river or water 22 bound. A system 70 can be incorporated at a traditional rail yard 71 with railway tracks 36. In the rail support system 70 as shown, shelving systems 19 and 20 are not included but shelving systems 19 and 20 can be included if desired in a rail yard support system 70. In the embodiment of FIG. 6, cargo containers are moved using AGVs 14 directly from a pod 47 on inbound line 11 to a train 72, e.g., as depicted by arrow/line 61. Likewise, cargo containers 48 from a train 72 can be moved using AGVs 14 directly from train 72 to a pod 47 on outbound line 12, e.g., as depicted arrow/line 63. Empty AGVs can leave an outbound train 72 in the direction of arrow/line 62 back to an offload gantry 13 at inbound line 11. Empty AGVs can also move from an onload gantry 13 after being unloaded at outbound line 12 to an inbound train 72 in the direction of arrow/line 66 to receive additional containers 48. An AGV 14 can also move from an offload gantry at inbound line 11 to a passenger station 16 in the direction of arrow/line 28. A bus from a passenger station can move in the direction of arrow 64 to an onload gantry 13 at outbound line 12. The lines and/or routes of travel depicted in FIG. 6 are examples. Multiple different lanes of travel or routes of AGVs 14 are preferably provided/programmed to help prevent erosion.

FIG. 7 depicts a preferred embodiment of a terminal facility which is a hub support system 75 which is also similar to a port support system 65, except cargo containers 48 on inbound line 11 are warehouse 76 bound instead of ocean or water bound. A system 75 can be incorporated at a typical big box distribution center. In the hub support system 75 as shown, shelving systems 19 and 20 are not included but shelving systems 19 and 20 can be included if desired instead of or in addition to warehouses 76, 77. In the embodiment of FIG. 7, cargo containers are moved using AGVs 14 directly from a pod 47 on inbound line 11 to a warehouse 76, e.g., in the direction of arrow/line 67. Likewise, cargo containers 48 from a warehouse 77 can be moved using AGVs 14 directly to a pod 47 on outbound line 12, e.g., in the direction of arrow/line 69. Empty AGVs can move in the direction of arrow/line 68 from warehouse 76 to offload gantry 13 at inbound line 11. Empty AGVs 14 can also move in the direction of arrow/line 93 to warehouse 77, which can be ocean bound, for example, from onload gantry 13 at outbound line 12 after loading cargo containers 48 on a pod 47 on line 12. An AGV 14 can also move from an offload gantry 13 in the direction of line 29 to a passenger station. An AGV 14 loaded with a passenger bus 17 can also move in the direction of arrow 74 to an onload gantry 13 at outbound line 12. Containers 48 can also be moved in the direction of arrow/line 78 from a truck (which can be at a position designated by numeral 95) to a warehouse 77 or 76 if desired. The lines and/or routes of travel depicted in FIG. 7 are examples. Multiple different lanes of travel or routes of AGVs 14 are preferably provided/programmed to help prevent erosion.

In viewing the figures, it should be understood that an inbound line 11 at a port support system 65 in FIG. 5 can also be an outbound line 12 at a hub support system 75 or an outbound line 12 at rail support system 70, for example. Likewise, an outbound line at a rail support system 70 or hub support system 75 can be an inbound line at a port support system 65. Although not shown, it is also possible that a first terminal location in the system and method of the invention can be a rail support system and a second terminal location in the system and method can be a hub support system. A first terminal location can be any desired location that receives and/or distributes cargo and a second terminal location can be any desired location that receives and/or distributes cargo.

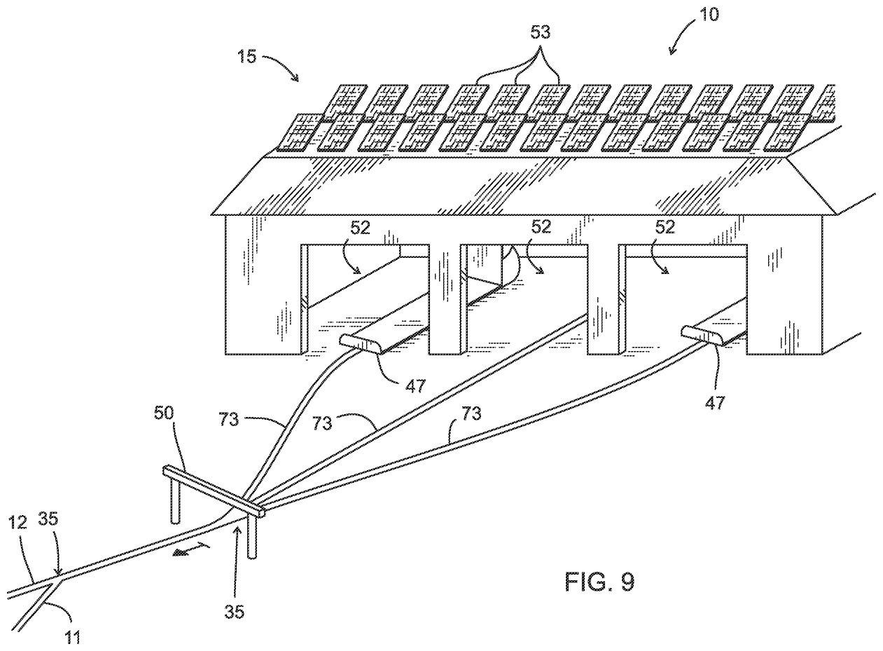

FIGS. 8 and 9 illustrate preferred embodiments of a maintenance facility 15 including 3 bays 52. A pod 47 can travel from line 11 to switch 35 and then to a selected line 73 into a bay 52 to receive any needed maintenance, e.g., parts, welding, repairs. When maintenance is completed a pod 47 can return back on a selected line 73 through switch 35 to outbound line 12. A pod 47 can be controlled through its programming at a control tower 18, for example, or manually if desired.

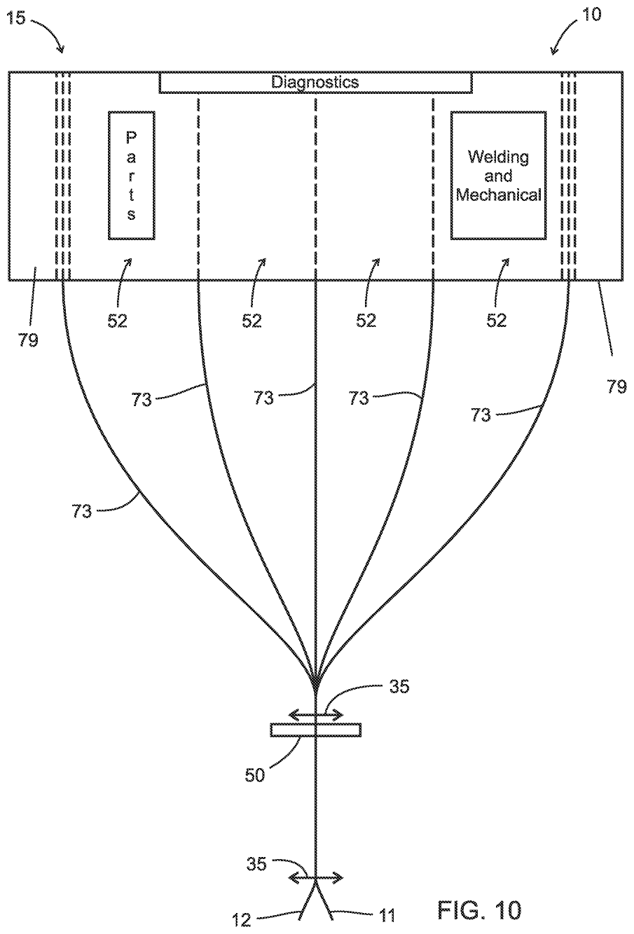

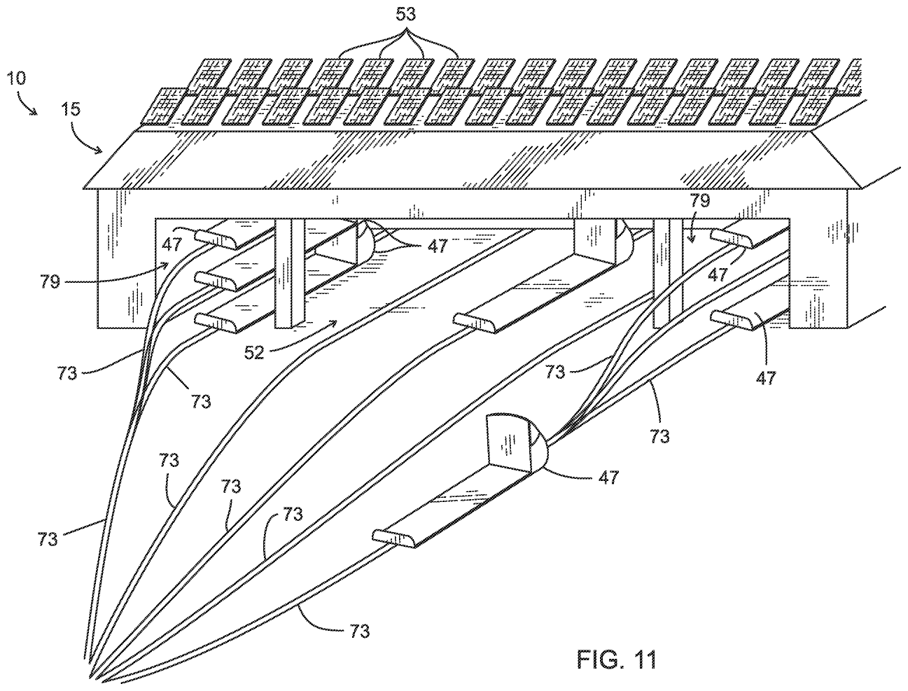

FIGS. 10 and 11 illustrate an alternate preferred embodiment of a maintenance facility 15 that also includes recharging bays 79 in addition to maintenance bays 52. As shown in FIG. 11, a stacked system of lines 73 can be provided for recharging multiple pods 47 in a single recharge bay 79. The stacking can be done, for example, by means of rails or lines 73 that lower and raise, which can be similar to what is used to load automobiles on a car-carrying truck.

Any desired numbers of bays 79 and/or 52 can be included in a maintenance facility 15 of the type depicted in FIGS. 8-11.

Entry/exit of pods or vehicles into/out of the maintenance zone or facility preferably is controlled manually to ensure safe and efficient introduction/extraction. In other embodiments, entry/exit of pods or vehicles into/out of the maintenance zone or facility can be automated or partially automated with some manual or human oversight.

FIGS. 12 and 13 illustrate a preferred embodiment of infrastructure that can be included in one or more preferred embodiments of the system and method of the present invention, including with embodiments of the system and method utilizing pods, vehicles or trainsets 47, 101 and/or 121. A turntable/trestle 54 can be provided enabling pods, vehicles or trainsets 47, 101, or 121 to make sharp turns in a designated route. Preferably a turntable/trestle 54 of the present invention is a mechanism that enables transportation line 83 to perform turns of any angle, especially when limited by rights-of-way (ROW) whose linear representation features sharp turns. The ROW available between a port and an inland transfer facility, for example, must often pass through congested and urbanized geographic areas with little, if any, allowance for wide turns. One or more embodiments of a turntable 54 of the present invention preferably provide a means by which different sections of a transportation line 83 can intersect at any desired angle, connected by the turntable 54, which can be a trestle-type turntable. Preferably a turntable 54 of the present invention is elevated as a safety measure to prevent at-grade interaction with pedestrians and/or motorists. Prior to reaching a turntable 54, a pod, vehicle or trainset 47, 101, 121 can be signaled to decelerate by sensors imbedded in a transportation line. A turntable 54 preferably is guarded by entry gates 50 that require the oncoming trainset, pod or vehicle 47, 101, 121 to come to a full stop before engaging the turntable or trestle 54, which preferably has a pair of guide rails 55 (which can also be a track or guideline) built in to match guide rails 55 of the entering/exiting transportation line 83. Once engaged, turntable 54 can align its built-in guide rails 55 with mating guide rails 55 on those of the entering pod, vehicle or trainsets 47, 101, 121, open a gate 50, signal for a trainset, pod or vehicle 47, 101, 121 to enter, stop the pod, vehicle or trainset 47, 101, 121 and close the gate 50. The turntable 54 then can rotate to align its guide rails 55 with guide rails 55 of the exit direction, stops, and signals the trainset, pod or vehicle 47, 101, 121 to exit. The trainset, pod or vehicle 47, 101, 121 can then accelerate to its next destination, whether a terminal or another turntable 54.

A turntable 54 can be adapted to accommodate different sizes of pods, vehicles or trainsets 47, 101, 121 depending on which types of pods, vehicles or trainsets 47, 101, 121, e.g., how long they are based on how many cargo containers they carry, are used in the system and method.

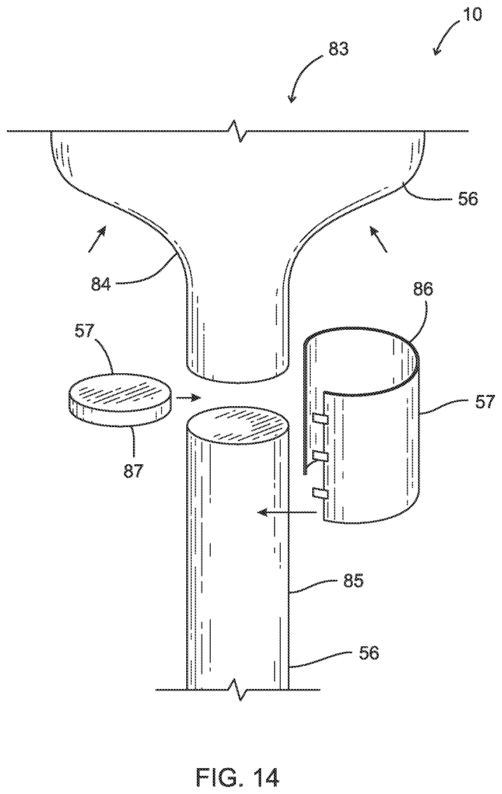

FIG. 14 is an exploded view of a shim system 57, including a shim 87 and a locking collar 86 that can be incorporated in support pilings 56 of a transportation line 83. A support piling 56 can include an upper portion 84 and a lower portion 85 wherein a locking collar 86 couples upper portion 84 and lower portion 85 together. If settlement occurs, locking collar 86 can be removed from piling 56. Upper portion 84 can be lifted, e.g., by crane or jacks, and a shim 87 of desired thickness, e.g., 0.5 to 1 foot or more (0.152 to 0.305 or more meters), based on the amount of ground settlement and to offset the ground settlement, can be inserted between upper portion 84 and lower portion 85 of support column 56. A shim 87 can be made of concrete, for example, or made from any other desired material that meets weight-bearing requirements. Locking collar 86 can then be placed back onto column 56 to secure upper portion 84, shim 87 and lower portion 85 in position. Locking color 86 can be made of metal.

FIG. 15 illustrates a passenger station 16 and passenger bus 17. A passenger bus 17 can be of a size that is the same or similar to an FEU or TEU container 48 used in preferred embodiments of the system and method of the present invention, or of a same or similar size to other cargo containers 48 chosen for use in the system and method. A passenger bus 17 being of the same or similar size as a container 48 used in the system and method allows for a passenger bus 17 to be secured to an AGV 14 in a same or similar manner as a container 48, e.g., using a clamp system or fitted recess system. A passenger bus 17 can also be lifted and moved in a same or similar manner as a cargo container 48. An AGV 14 used to transport a passenger bus 17 thus can be the same or similar as an AGV 14 used to transfer a cargo container 48. If desired specialized AGVs for use with just passenger buses 17 can be provided in a system and method, e.g., if a passenger bus 17 is of a different size than containers 48, but there will be cost savings if the same AGVs are used for both containers 48 and passenger buses 17.

AGVs 14 transporting passenger buses 17 can be programmed at a control tower 18 to proceed to a passenger station 16 from an inbound gantry 13 at line 11 or to move from a passenger station 16 to an outbound gantry 13 (or gantry at line 12. Passenger buses 17 can be designated for movement from a passenger station 16 every 30 minutes for example, or based on any desired time intervals.

An outbound passenger bus 17 can debark from a passenger station 16 and be moved by an AGV 14 to an onload gantry 2 (see FIG. 2) at outbound line 12 if debarking to another terminal station/terminal end 10, 100, 120, 130 for example. At out bound gantry 2, passenger bus 17 can be removed from AGV 14 when a crane secures and lifts passenger bus 17 and then moves and lowers passenger bus 17 to a pod, vehicle or trainset 47, 101, 121 to which the passenger bus 17 can be secured. The pod 47, 101, 121 can then wait for the gate to be cleared before debarking. A passenger bus 17 can also debark from a passenger station 16 and be moved by an AGV 14 to another location at the same terminal station/terminal end 10, 100, 120, 130, e.g. to a warehouse, or automated shelving system, or to ships, trains, trucks, etc. at the terminal station for transporting personnel around the terminal station/terminal end 10, 100, 120, 130 as needed.

An inbound passenger bus 17 on a pod, vehicle of trainset 47, 101, 121 on line 11 and also be moved from pod, vehicle or trainset 47, 101, 121 on line 11 to an AGV 14 via a crane 46 at an offload gantry 1 at line 11. Said AGV 14 can then transport the passenger bus 17 to passenger station 16 or to another desired location at the terminal station 10, 100, 120, 130. For example, gate 50 on inbound line 11 can open with a pod, vehicle or trainset 47, 101, 121 that is carrying a passenger bus 17 moving forward to the offload gantry 13 at line 11. The gantry 13 can secure the passenger bus 17 with crane 46 and lift and transfer passenger bus 17 to an AGV 14 which can then transfer passenger bus 17 to a passenger station 16 for unloading.

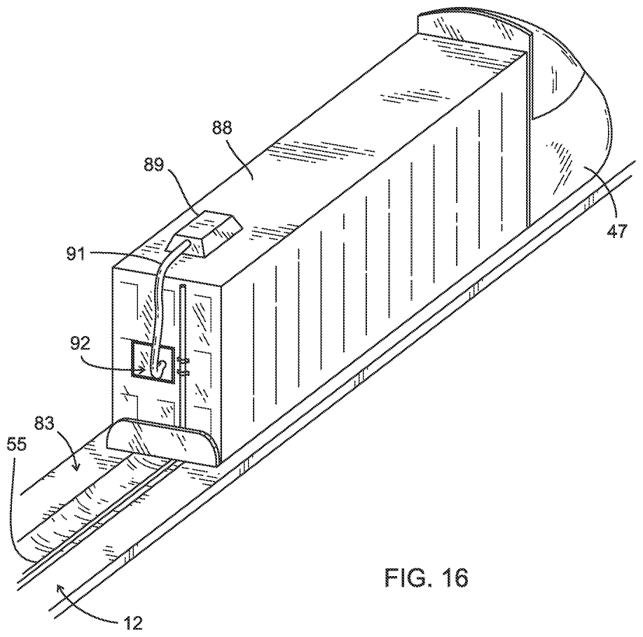

In FIG. 16, a refrigerated container 88 is depicted, which can include a battery 89, which can be temporarily mounted on top of a refrigerated container 88 and plugged in with plug 91 at outlet/plug-in area 92. A refrigerated container 88 does not have to include a battery 89. A refrigerated container can be transported on a trainset or pod 47, 101, 121 in a same or similar manner as a cargo container 48 as shown and described herein. AGVs 14 can carry refrigerated containers 88 to reefer racks 24 as shown in FIGS. 5, 7 where they can also be plugged in, e.g., instead of stored at a shelving system 19, 20 or warehouse 76, 77. At a rail support system 70, reefer racks 24 can also be included. Refrigerated containers 88 can also be plugged in and/or kept cold at refrigerated train cars during further transport and while on a pod 47 if a pod 47 is equipped with an electrical outlet.

FIG. 17 illustrates another preferred embodiment of the present invention that accommodates trainsets 101. A terminal end 100 with a load/unload zone 110 is shown that is designed to accommodate trainsets 101 that can carry more than one container 48, e.g., a plurality of containers 48, e.g., ten containers 48 which can be ten FEU containers, or 20 TEU containers, for example. A terminal end 100 can be, for example, located at a port 65, at a traditional rail yard 70, at a distribution hub 75 or at another desired inland location that is a terminal end/station.

A trainset 101 can travel along a transportation line 83 in a same or similar manner as a pod or vehicle 47. To enable savings on cost and space, preferably the number of gantries 13 provided at inbound and outbound lines 11, 12 corresponds to the number of containers 48 carried on a trainset 101. For example, preferably 10 gantries 13 with cranes 46 are included at a load/unload zone 110 with a trainset 101 that can transport 10 to 20 containers 48 as shown in FIG. 17, 25-31. Preferably, gantries 13 can be moved from one side of a transportation line 83, e.g., along outbound line 12 of transportation line 83, to another side of transportation line 83, e.g., along inbound line 11. A trainset 101 can also move from one line 11 or 12 to the other line 11 or 12 at switch track 35. A trainset 101 can also have additional container wagons or wells if desired.

FIG. 17 illustrates gantries 13 with cranes 46 along outbound line 12. A trainset 101 is on inbound line 11 loaded with ten containers 48. A trainset 101 that can hold 10 FEUs or 20 TEUs can be about 650 feet (215 m) long. Ten AGVs 14 are positioned alongside line 11 ready to receive containers 48 from trainset 101. The gantries 13 can be moved from along line 12 to along line 11 to effect the unloading of containers 48. If desired, another set of 10 gantries (or duplicate set of gantries 13 corresponding to the number containers 48 carried by a trainset 101) can be included along line 11 as well, which will allow for faster rates in loading/unloading containers 48 but will include overall additional cost a terminal end 100. Another set of ten AGVs are shown in FIG. 17 already loaded with other containers 48 ready for moving to a ship 23 or to a shelving station 19, 20, or to a warehouse 76, 77, for example.

A load/unload zone 110 designed to accommodate trainsets 101 that can carry 10 FEU containers can be about 500 feet (152.4 m) long by 140 feet (42.67 m) wide, e.g., for loading and unloading a trainset 101 carrying 10 FEU containers 48. A total land area for a terminal end 100 can preferably be about 3.8 acres (15,378.1 square m). A total land area for a terminal end 100 that accommodates trainsets 101 can also be about 4 to 5 acres 16,187.4 to 20,234.3 square m), which still has a significantly smaller footprint than a traditional rail yard that accommodates trains that can be a mile (1.609 km) long, for example, needing 20 to 40 acres (80,937 to 161,874 square m).

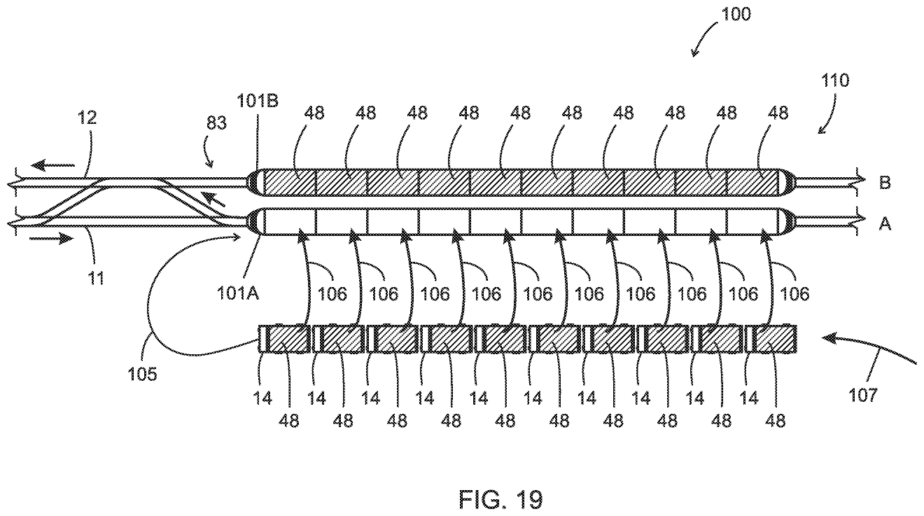

FIGS. 18-19 depict/list three phases in a preferred embodiment of the method of the present invention at a terminal end 100. In phase 1 as shown in FIG. 18, trainset 101A along line 11 is unloaded. To unload a trainset 101, gantries 13 can be used to move containers 48 to AGVs 14. AGVs 14 preferably can carry one FEU or two TEUs or other desired sized containers 48, but they can also be made to accommodate an additional number of containers if desired.

FIG. 18 illustrates unloading a trainset 101A that is on inbound line 11. Although not shown, gantries 13 are moved along line 11 to enable unloading of containers 48 from trainset 101A on inbound line 11 in the direction of arrows 103 onto AGVs 14. FIG. 18 also illustrates another trainset 101B at switch 35 moving to outbound line 12. If terminal end 100 is a port 65, AGVs 14 can then carry the containers 48 in the direction of arrow 104 to a ship 23, for example, or to a shelving station 19, 20 or warehouse 76, 77, as desired. If desired, unloading of containers in phase one can be done in cycles. In a first cycle, odd numbered containers 48 can be unloaded in 0 to 40 seconds. In a second cycle, even number containers 48 can be unloaded in 20 to 60 seconds (1 minute).

FIG. 19 illustrates Phase 2 in which trainset of vehicles 101A is next loaded with shipping containers 48. If terminal end 100 is a port, for example, AGVs 14 can carry containers 48 received from a ship 23, or from an inland bound 19 or outland bound 20 automatic shelving system or from an inland bound 76 or outland bound 77 warehouse, as desired, in the direction of arrow 107 to load/unload zone 110 where trainset 101A can be loaded with the containers 48 in the direction of arrow 105. Gantries 13 with a crane 46 can move containers 48 from AGVs 14 to trainset 101A in the direction of arrows 106. If desired, loading of containers can be done in cycles in phase 2. In a first cycle of phase 2, odd-numbered containers 48 can be loaded between the 1-minute and 1 minute 40 seconds marks. In a second cycle of phase 2, even-numbered containers 48 can be unloaded between the 1 minute 20 seconds and 2 minute mark. Phase one and phase two phases of unloading trainset 101A and loading trainset 101A can be done in about 2 minutes.

In phase 3, trainset 101A departs and gantries 13 are moved to be positioned along outbound line 12 to repeat the cycle and conduct phase 1, unloading of trainset 101B on line 12 and phase 2, loading of trainset 101B on line 12. In another phase 3 trainset 101B departs and gantries 13 can be moved back to be positioned along line 11. If gantries 13 are included along both lines 11 and 12, phases 1 and 2 can be conducted at the same time for both a trainset 101A and a trainset 101B.

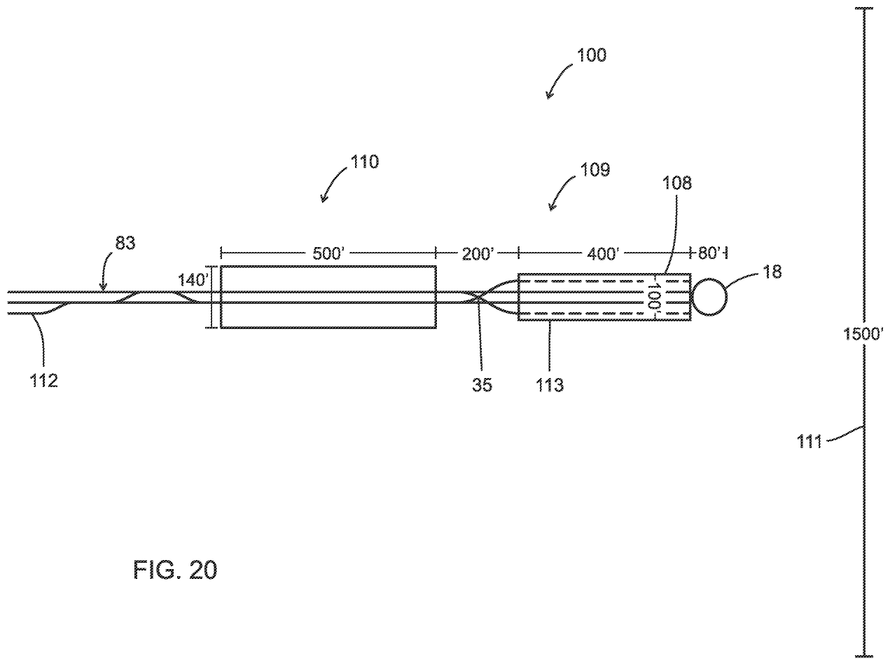

In FIG. 20, a load/unload zone 110 (which can be about 140 feet (42.672 m) wide by 500 feet (152.4 m) long), a combined passenger/maintenance zone 109 (which can be about 100 feet (30.48 m) wide by 400 feet (121.92 m) long), a control tower 18 which can be about 80 feet (24.384 m long), and a pier 111 (which can be about 1500 feet (457.2 m) long) with 6 gantries 13/cranes 46 is shown schematically as part of a terminal end 100 which is depicted at a port. A parking track 112 is also shown, which can be included if desired in various embodiments of a terminal or terminal end 100 as described herein. At the discretion of the port or rail yard, a terminal end 100 can also include one or more inland bound 19 or outland bound 20 automatic shelving stations and/or inland bound 76 or outland bound 77 warehouses as desired but these are not required to be included in the WickedHyper™ systems. A passenger/maintenance zone 109 can include a passenger station 108 on one side and maintenance facility 113 on the other side. A terminal end 100 as shown in FIG. 20 with a load/unload zone 110 and maintenance facility 113 can accommodate trainsets 101 that can carry multiple cargo containers 48, e.g., 10 FEU or 20 TEU containers, with a maximum lift rate of about 300 FEUs/hour and maximum sustainable annual capacity of about 7.4 TEUs. An example of a trainset 101 that can be used is a VHO Cargo Speed™. Land area size of a system as shown in FIG. 20 can be about 3.8 acres (15,378.1 square m).

A passenger station 108 of a combined passenger/maintenance zone 109 can be similar to a passenger station 16 with an area for passengers to wait and space to accommodate a passenger container or bus 17. A maintenance zone 113 can be similar to a maintenance facility 15 as shown in FIGS. 8-11 and adapted to accommodate the longer trainsets 101. A passenger/maintenance zone can preferably be about 400 feet (121.92) long by 80 feet (24.38) wide, or about 300 to 600 feet (91.44 to 182.88 m) long by 80 to 120 feet (24.38 to 36.58 m) wide. If desired, a combined passenger/maintenance zone can also be included in other terminal end embodiments, e.g., with terminal ends adapted to accommodate pods or vehicles 47 and/or pods or vehicles 121, or trainsets, pods or vehicles adapted to accommodate 1 to 20 containers, for example.

FIG. 21 illustrates a terminal end 120 with a load/unload zone 122 adapted to accommodate pods or vehicles 121 that can carry more than one container 48, e.g., two containers 48, e.g., two FEUs, or four containers 48, e.g., 4 TEUs. A vehicle or pod 121 can be about 90 feet (27.432 m) long. Terminal end 120 includes a combined passenger/maintenance zone 109 with passenger station 108 and maintenance facility or zone 113. A passenger/maintenance zone 113 can be about 200 feet (60.96 m) wide by 100 feet long (30.48 m). Terminal end 120 can also include separate passenger stations and maintenance facilities if desired, e.g., as shown in FIGS. 5-11, 15. A terminal end 120 can be 3 to 6 acres (12,140.6 to 24,281.1 square m). A load/unload zone at terminal end 120 can be 200 to 400 feet (60.96 to 121.92 m) long by 80 to 160 feet (24.38 to 48.77 m) wide. At terminal end 120, two gantries 13/cranes 46 are shown, which are moveable from along one line 11, 12 to the other line 11, 12. Two gantries 13/cranes 46 can be take up about 100 feet (30.48 m). If desired more gantries 13/cranes 46 can be included so that gantries can be along each line 11, 12, which will allow for faster load/unload rates but will add to the overall cost for a terminal end 120.

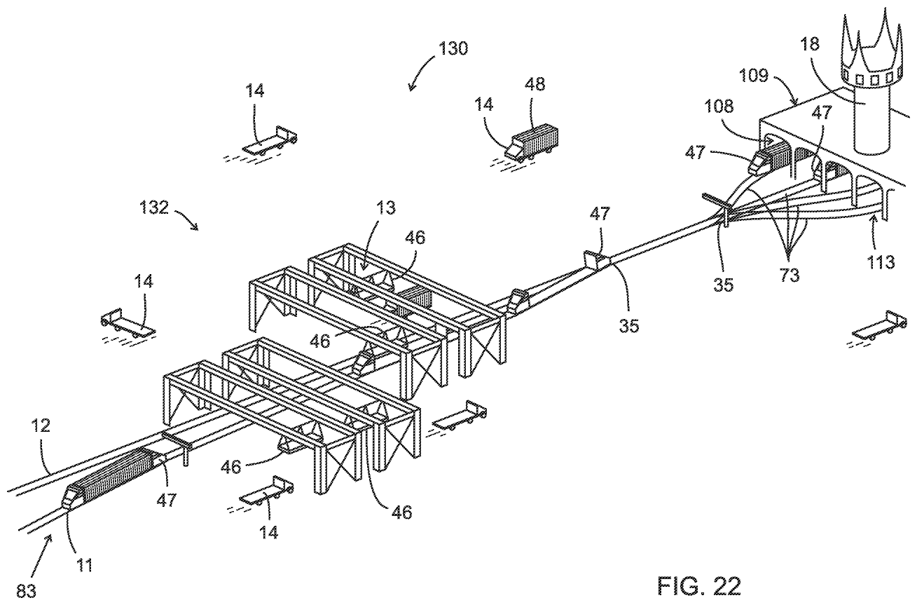

FIG. 22 illustrates a terminal end 130 with a load/unload zone 132 adapted to accommodate pods or vehicles 47 that can carry 1 container 48, e.g., one FEU or two TEUs. Terminal end 130 includes a combined passenger/maintenance station 109 with passenger station 108 and maintenance facility or zone 113. Terminal end 130 can also include separate passenger stations and maintenance facilities if desired, e.g., as shown in FIGS. 5-11, 15. A terminal end 130 can be 3 to 6 acres (12,140.6 to 24,281.1 square m). A load/unload zone 132 at terminal end 130 can be about 100 to 200 feet (30.48 to 60.96) long by 80 to 120 feet (24.38 to 36.58 m) wide. At terminal end 130, two gantries 13/cranes 46 are shown, one on each side of line 11 and 12. If desired, only one gantry 13/crane 46 can be included that would be moveable from along one line 11, 12 to the other line 11, 12. If desired additional gantries 13/cranes 46 can be included, which will allow for faster load/unload rates but will add to the overall cost for a terminal end 130.

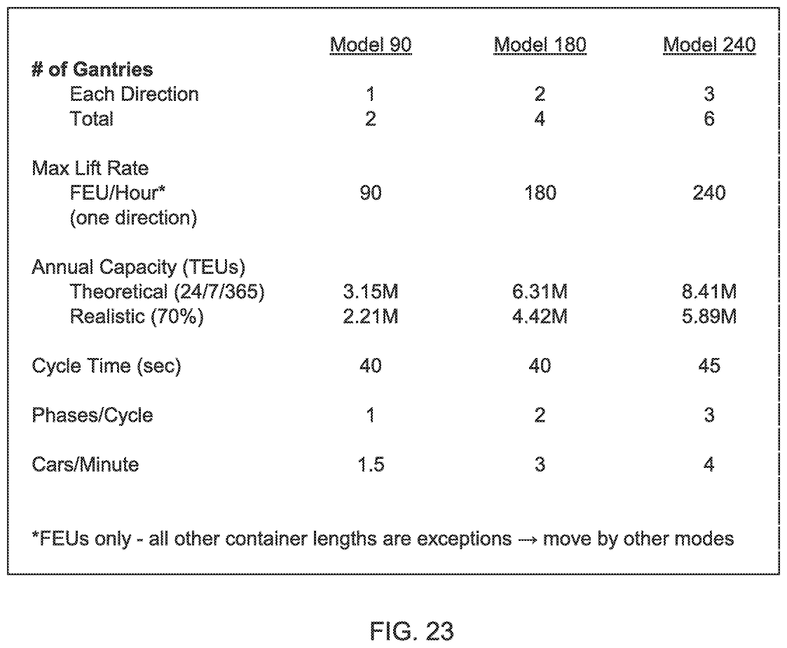

FIG. 23 is a chart listing example rate and efficiency data for a terminal end that accommodates pods or vehicles 47, e.g., a terminal end 130 as shown in FIG. 22.

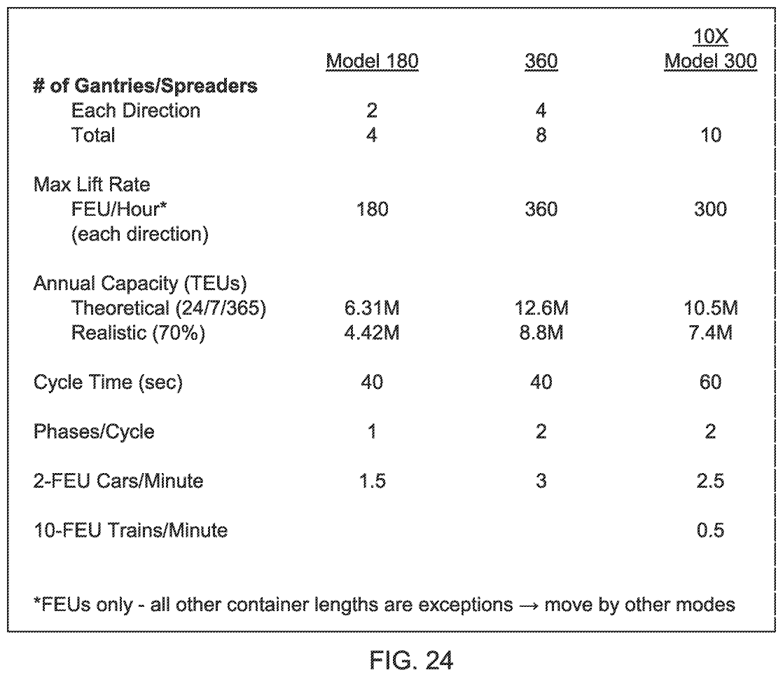

FIG. 24 is a chart listing example rate and efficiency data for terminal ends that accommodate pods or vehicles 121 and trainsets 101.

Referring now to FIGS. 25-32B, another preferred embodiment of a system and method of the present invention is illustrated at a port terminal end/station 140. A similar system and method can also be utilized at rail or hub or other desired type of terminal stations/terminal ends. FIG. 25 shows an overview of a port facility including ship-to-shore cranes 141 that can transport containers from a ship or barge 23 in water 22 to on shore at terminal end/system 140. In FIGS. 25-31, a dashed line/arrow represents a preferred route for an AGV 14 that is not loaded with a container, and a regular, non-dashed line/arrow represents a route for an AGV 14 that is loaded with a container. Line/arrow 142 represents a possible path for travel of loaded AGVs 14 with a container 48 from load/unload station 110 to ship-to-shore cranes 141. Line/arrow 143 represents a possible path of unloaded AGVs 14 from ship-to-shore cranes 141 to load/unload zone 110. Line/arrow 144 represents a possible path of unloaded AGVs 14 from load/unload station 110 to ship-to-shore cranes 141. Line/arrow 145 represents a path of loaded AGVs 14 from ship-to-shore cranes 141 to load/unload zone 110. Line/arrow 146 represents a possible path of loaded AGVs 14 from ship-to-shore cranes 141 to load/unload zone 110. Line/arrow 147 represents a possible path of unloaded AGVs 14 from load/unload zone 110 to ship-to-shore cranes 141. Line/arrow 148 represents a possible path of unloaded AGVs 14 from ship-to-shore cranes 141 to load/unload zone 110. Line/arrow 149 represents a possible path of loaded AGVs 14 from load/unload zone 110 to ship-to-shore cranes 141. Line/arrow 150 represents a possible route for exceptions, e.g., containers not destined for an inland terminal. The routes for loaded and unloaded AGVs 14 are preferred examples, and preferably there are multiple planned route or lanes of travel, e.g., with slight variations, to help prevent or lessen erosion.

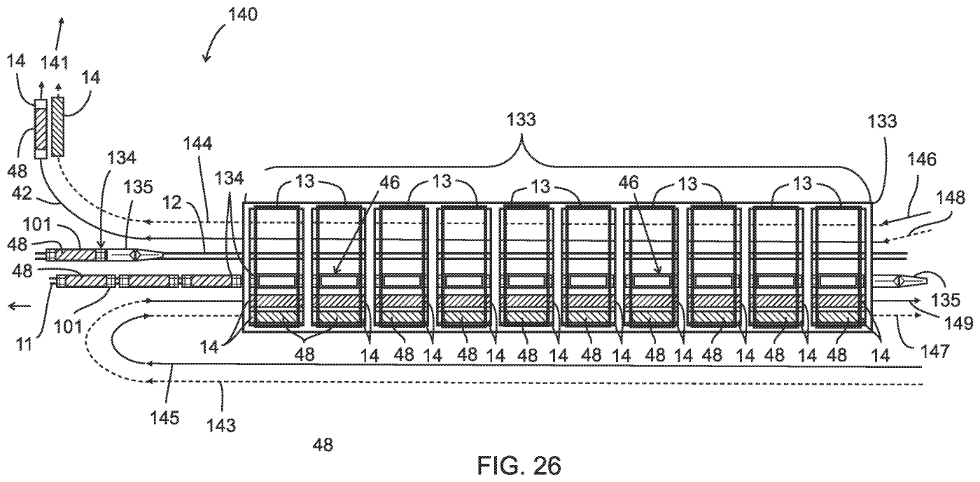

FIG. 26 illustrates a Pre-Stage 1 in the method. This can correspond to the end of Stage 5 for the trainset 101 departing on outbound line 12. A first twenty AGVs 14 have arrived in position under a gantry system 133, referred to sometimes herein as a mega gantry or WickedHyper LOAD 10×MegaGantry™, that includes 10 individual fixed gantries 13, which are sometimes referred to herein as HyperGantries™. Each gantry 13 can include a crane 46, which can be an autonomous crane, e.g., of the type commercially available from Kalmar. In FIG. 26, 10 empty AGVs 14 in are in an inner lane nearest the inbound rail 11 (in line with arrows 143/149) and 10 loaded AGVs 14 with containers 48 thereon are in an outer lane furthest from the inbound line 11 (in line with arrows 145/147). In this embodiment, a trainset 101 can have 20 container wagons or well cars 134 and 2 locomotives 135 (one on each end, facing outward). Each container wagon or well car 134 is preferably capable of holding a 40 (12.192 m) or 45 (13.716 m) foot container or two 20-foot (6.096 m) containers. Trainsets are constructed by putting together locomotives and well cars using couplings, e.g., a standard coupling device, similar to those used for conventional trains. A container wagon or well car 134 can be of the type available from Greenbrier Companies, a US manufacturer, e.g., a Maxi Stack™ I Car. A trainset 101 can have even more container wagons or well cars 134 if desired, e.g., 20 to 30 well cars, for possibly carrier additional containers 48 but preferably the trainset is not too large as to require additional acreage or land area.

In FIG. 26, 10 empty AGVs 14 in are in a lane nearest the inbound rail 11 and 10 loaded AGVs 14 with containers 48 therein are in the lane furthest from the inbound line 11. In this embodiment, a trainset 101 can have 20 container wagons 134 and 2 locomotives 135 (one on each end, facing outward). In FIG. 26, trainset 101 has arrived through the mega gantry 133 into a Position #1, aligning the first 10 container wagons with the gantries 13. Cranes 46 on each of the gantries 13 have moved from an opposite rail top position over the container wagons. The timer begins at this pre-stage 1.

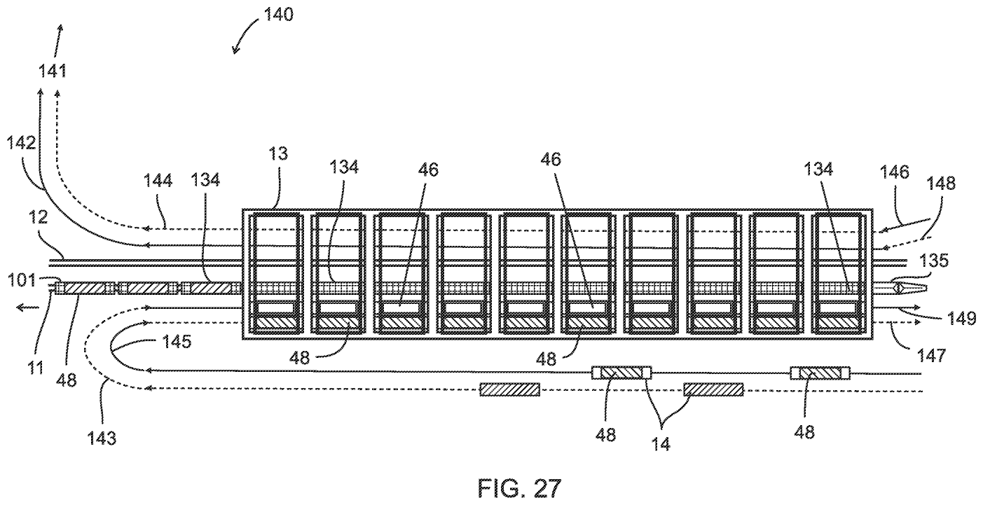

FIG. 27 illustrates stage 1 of the method. Stage 1 takes about 40 seconds, beginning at 0:00 and ending at 0:40 on a timer. Cranes 46 lower spreaders 137 (see e.g., FIG. 4) onto containers 48 on container wagons 134 of trainset 101. The crane 46 spreaders secure containers 48 and lift containers 48. Cranes 46 preferably move containers 48 to positions directly over empty or unloaded AGVs 14 in the lane nearest to line 11, e.g., in line with arrows 143/149. Cranes 46 lower containers 48 onto said AGVs 14. The spreaders 137 of cranes 46 release containers 48. Cranes 46 raise empty spreaders 137. Newly loaded AGVs 14 depart for ship-to-shore (STS) cranes 141 at quayside, e.g., in the direction of arrow 149. Cranes 46 move to positions directly over loaded AGVs 14 (e.g., in outer lane in line with arrows 145/147). New empty AGVs 14 (e.g., 10 empty AGV's 14) begin arriving to replace departed AGVs 14.

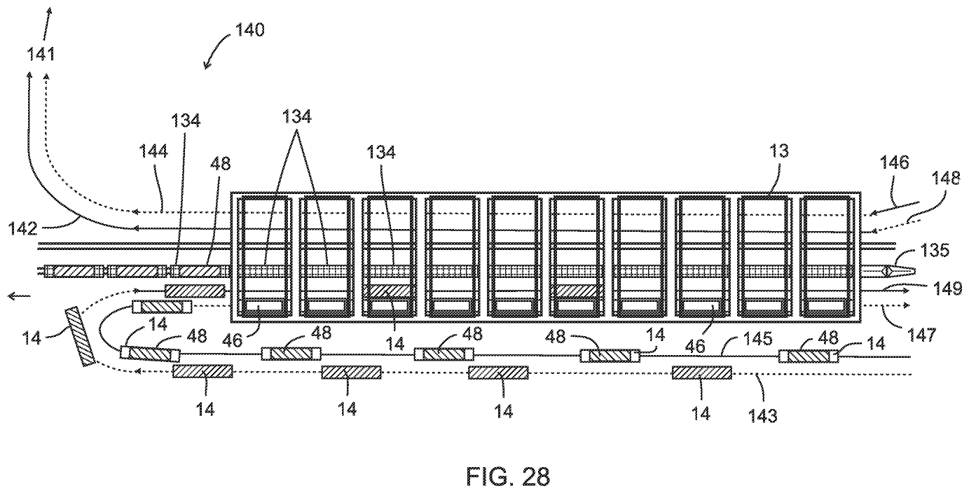

FIG. 28 illustrates stage 2 of the method. Stage 2 takes about 50 seconds, beginning at 0:40 and ending at 1:30 on a timer. Cranes 46 lower spreaders 137 onto containers 48 on AGVs 14 in the outer lane in line with arrows 145/147. Spreaders 137 secure containers 48. Cranes 46 lift containers 48. Cranes 46 move containers 48 to positions directly over trainset 101 empty container wagons 134. Cranes 46 lower containers 48 onto container wagons 134. Spreaders 137 release containers 48. Cranes 46 raise empty spreaders 137. Newly empty AGVs 14 depart for STS cranes 46 at quayside, e.g., in the direction of arrow 147. Newly loaded AGVs 14 begin arriving to replace departed AGVs 14.

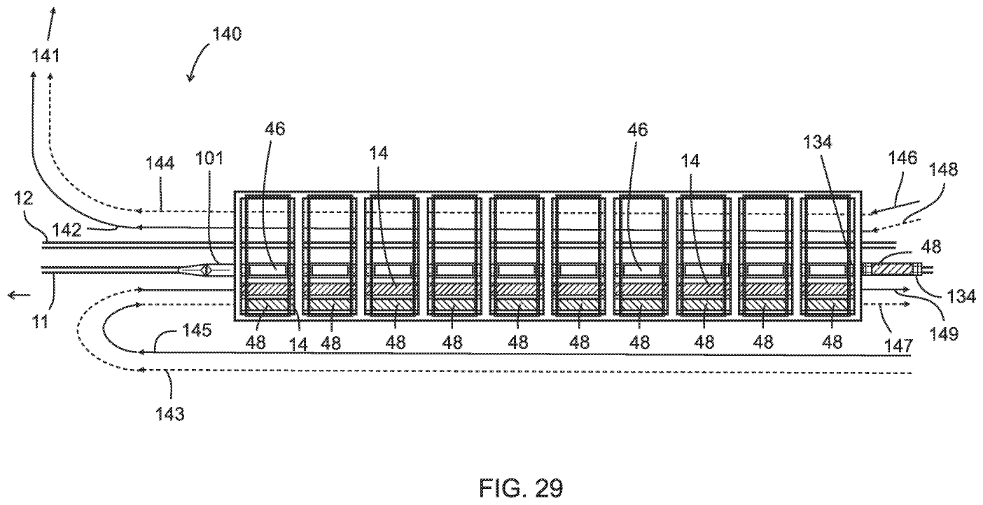

FIG. 29 illustrates stage 3 of the method. Stage 3 takes about 60 seconds, beginning at 1:30 and ending at 2:30 on the timer. Trainset 101 pulls forward, e.g., about 520 feet (148.496 m) to a Position #2, aligning the second 10 container wagons 134 with the gantries 13. All 20 new AGVs 14 having—10 empty container wagons 134 and 10 loaded container wagons are arrived and in position in the inner and outer lanes near line 11.

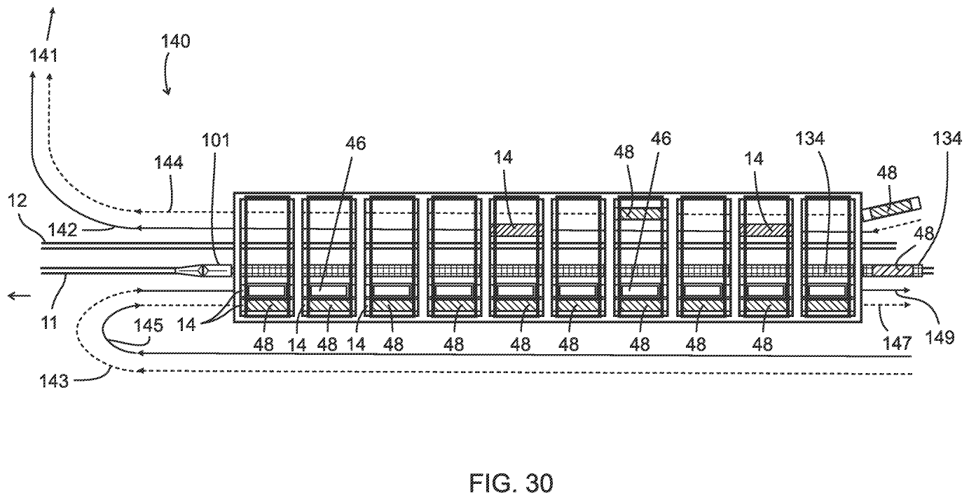

FIG. 30 illustrates stage 4 of the method. Stage 4 takes about 40 seconds, beginning at 2:30 and ending at 3:10 on a timer. Cranes 46 lower spreaders 137 onto containers 48 on container wagons 134 of trainset 101. Spreaders 137 secure containers 48. Cranes 46 lift containers 48. Cranes 46 move containers 48 to positions directly over empty AGVs 14 in the inner lane near line 11 that is in line with arrows 143/149. Cranes 46 lower containers 48 onto said AGVs 14. Spreaders 137 release containers 48. Cranes 46 raise empty spreaders 137. Newly loaded AGVs 14 depart for STS cranes 46 at quayside, e.g., in the direction of arrow 149. Cranes 46 move to positions directly over loaded AGVs 14 (e.g., in outer lane in line with arrows 145/147).

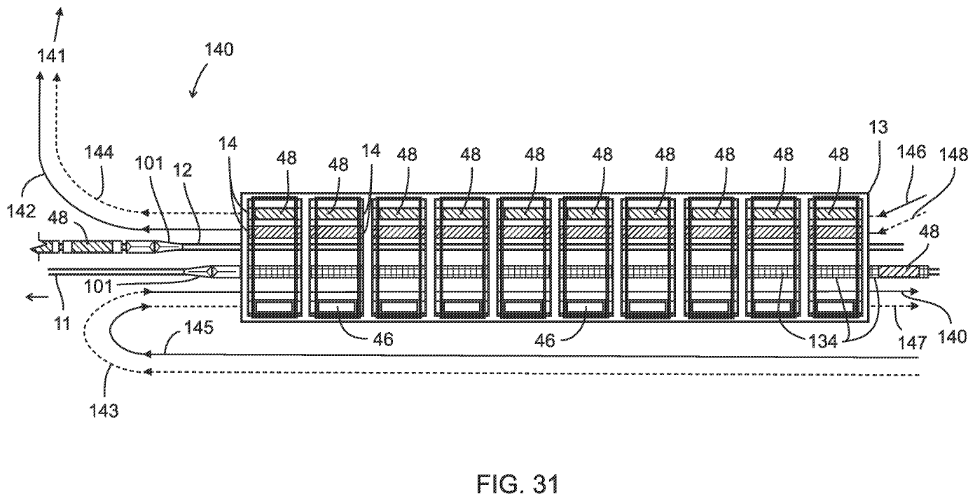

FIG. 31 illustrates stage 5 of the method. Stage 5 takes about 50 seconds, beginning at 3:10 and ending at 4:00 on a timer. Cranes 46 lower spreaders 137 onto containers 48 on AGVs 14, e.g., in an outer lane in line with arrows 145/147. Spreaders 137 secure containers 48. Cranes 46 lift containers 48. Cranes 46 move containers 48 to positions directly over trainset 101 empty container wagons 134. Cranes 46 lower containers 48 onto container wagons 134. Spreaders 137 release containers 48. Cranes 46 raise empty spreaders 137. Newly empty AGVs 14 depart for STS cranes 46 at quayside, e.g., in the direction of arrow 147. Trainset 101 departs for off-dock container yard, e.g., another terminal end/station. Cranes 46 move to positions over the opposite rail line of transportation line 83.

In the embodiment(s) as shown in FIGS. 25-32B, a maintenance facility can have bays 52 for maintenance and bays 79 for recharging. With longer trainsets multilevel bays are not preferred. A terminal end as shown in FIGS. 25-32B that is a port or rail yard do not need to also have warehouses, auto-shelving facilities, refrigeration facilities or passenger stations, but these can be included if desired. A terminal end that is a hub for a big box retailer, for example, also does not need to have warehouses, auto-shelving facilities, refrigeration facilities or passenger stations, e.g., if there is direct transport to trucks, for example, but a hub terminal end can have warehouses, auto-shelving facilities, refrigeration facilities, or passenger stations if desired.

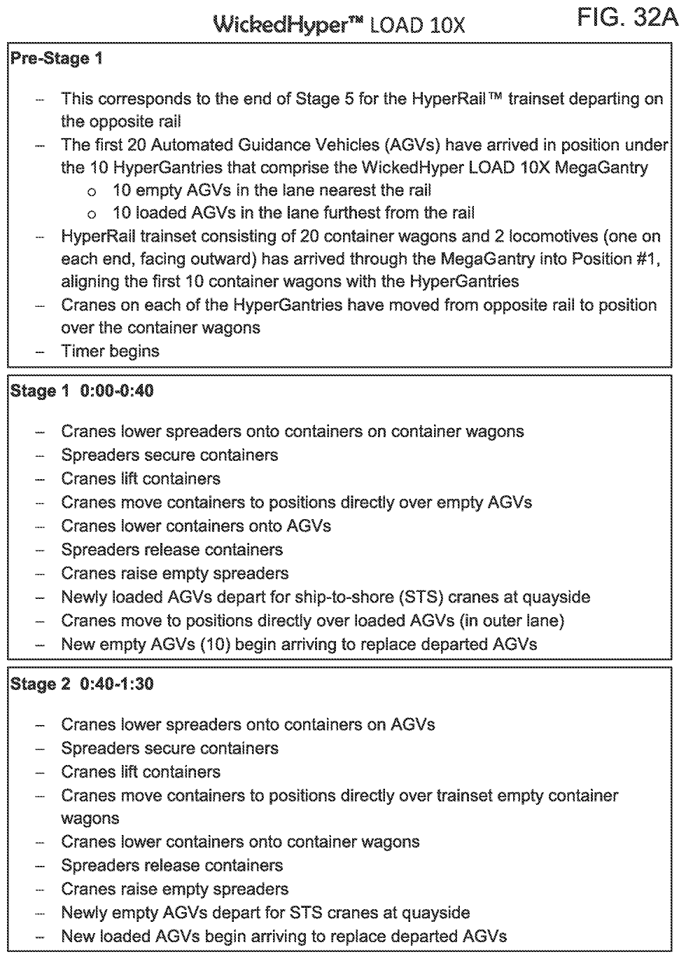

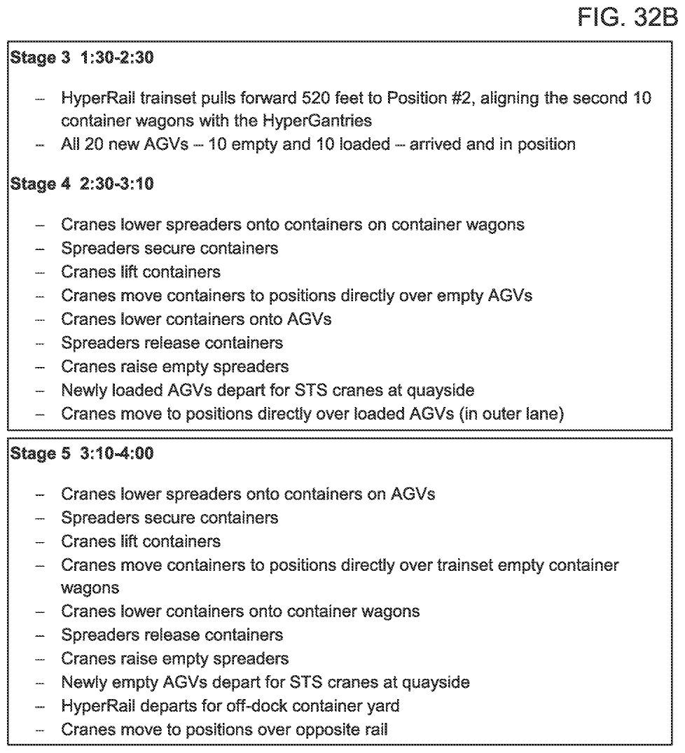

FIGS. 32A-32B is a chart including preferred steps in the 5 stages as shown in FIGS. 26-31.

In one or more preferred embodiments the WickedHyper loading/unloading and maintenance facility at a terminal end has a footprint of about 3 to 6 acres (12,140.6 to 24,281.1 square m). Terminal ends can also have larger footprints if desired or land area is available. The entire WickedHyper™ system at a terminal end, which the AGV paths to and from the ship-to-shore cranes, has a footprint of about 16-19 acres (64,749.7-76,890.3 square meters).

As shown and described herein, included in one or more preferred embodiments of the cargo container transportation system and method, are solutions for loading/unloading shipping containers at Hyperrail™ terminals (ports, rail yards, distribution centers), maintaining/recharging Hyperrail™ vehicles and automated guidance vehicles, negotiating tight right-of-way scenarios, enabling passenger transportation on the Hyperrail™ line, forecasting/alleviating ground settlement effects, and maximizing efficiency for refrigerated container movement. Preferred embodiments of the system and method of the present invention blends automated and human operations to ensure the highest degrees of safety and efficiency.

The following is a list of parts and materials suitable for use in the present invention:

### PARTS LIST

| PART NUMBER | DESCRIPTION |
|---|---|
| 1 | offload gantry |
| 2 | onload gantry |
| 10 | terminal end/terminal station/port or |
| | port Hyperrail load/unload maintenance |
| | system |
| 11 | inland bound line |
| 12 | ocean bound line |
| 13 | Hypergantry/automated gantry |
| 14 | AGV/automated guidance vehicle |
| 15 | maintenance facility or maintenance/ |
| | recharge facility |
| 16 | passenger station |
| 17 | passenger container/passenger bus |
| 18 | control tower/operations tower |
| 19 | shelving system/automated shelving |
| | station, e.g., an inland bound automated |
| | shelving station |
| 20 | shelving system, e.g., an ocean bound |
| | automated shelving station |
| 21 | barge/Panamax/ship |
| 22 | river/body of water |
| 23 | river ship/ship |
| 24 | reefer racks |
| 25 | arrow/line to ocean bound automated |
| | shelving station |
| 26 | arrow/line to maintenance/recharge |
| | facility or passenger station |
| 27 | arrow/line to river/body of water |
| 28 | arrow/line to passenger station |
| 29 | arrow/line to passenger station |
| 30 | arrow/line to RTG outbound line |
| 31 | arrow/line to inland bound automated |
| | shelving system |
| 32 | arrow/line to ships/barges |
| 33 | arrow/line to outbound/onload gantry |
| 34 | arrow/line to inland bound automated |
| | shelving system |
| 35 | switch track/switch |
| 36 | railway tracks |
| 46 | crane |
| 47 | pod or vehicle |
| 48 | container/shipping container |
| 50 | gate |
| 52 | bay |
| 53 | solar panel |
| 54 | trestle/turntable |
| 55 | guide line/track/rail |
| 56 | pylon |
| 57 | shim system |
| 58 | load/unload zone/Wickedhyper Load |
| 60 | transportation line support system |
| 61 | arrow/line to out bound train |
| 62 | arrow/line to inbound/off-load gantry |
| 63 | arrow/line to outbound/on-load gantry |
| 64 | arrow/line to outbound/on-load gantry |
| 65 | port/port support system/WickedHyper |
| | Port |
| 66 | arrow/line to inbound train |
| 67 | arrow/line to inland warehouse |
| 68 | arrow/line to inbound/off-load gantry |
| 69 | arrow/line to outbound/on-load gantry |
| 70 | terminal end/rail yard support system/rail |
| | yard/WickedHyper Rail |
| 71 | rail yard |
| 72 | train |
| 73 | transportation line/line |
| 74 | arrow/line to outbound/on-load gantry |
| 75 | terminal end/hub support system/hub |
| | distribution hub/WickedHyper Hub |
| 76 | warehouse-inland bound |
| 77 | warehouse-ocean bound |
| 78 | arrow/line to warehouse |
| 79 | recharge bay |
| 80 | turn or wicked hyperturn |
| 81 | sensor deceleration/braking |
| 82 | sensor acceleration |
| 83 | transportation line |
| 84 | upper portion support column |
| 85 | lower portion support column |
| 86 | locking collar |
| 87 | shim |
| 88 | refrigerated container |
| 89 | battery |
| 91 | cord |
| 92 | plug-in/outlet |
| 93 | arrow/line to outbound warehouse |
| 94 | arrow/line to passenger station |
| 95 | truck |
| 100 | terminal end/terminal station |
| 101 | trainset of vehicles (e.g., 10-20 FEU |
| | container capacity) |
| 101A | trainset of vehicles (e.g., 10-20 FEU |
| | container capacity) |
| 101B | trainset of vehicles (e.g., 10-20 FEU |
| | container capacity) |
| 103 | arrow |
| 104 | arrow |
| 105 | arrow |
| 106 | arrow |
| 107 | arrow |
| 108 | passenger station |
| 109 | combined passenger/maintenance zone |
| 110 | load/unload zone |
| 111 | pier |
| 112 | parking track |
| 113 | maintenance and recharge facility/ |
| | maintenance station |
| 120 | terminal end/terminal station |
| 121 | pod or vehicle (e.g., 2 FEU capacity) |
| 122 | load/unload zone |
| 130 | terminal end/terminal station |
| 132 | load/unload zone |
| 133 | gantry system/mega gantry |
| 134 | container wagon |
| 135 | locomotive end |
| 137 | spreader/crane spreader |
| 140 | port support system/port/port terminal |
| | end/WickedHyper Port |
| 141 | ship-to-shore crane |
| 142 | line/arrow loaded AGVs from |
| | load/unload station to ship-to-shore |
| | cranes |
| 143 | line/arrow unloaded AGVs from |
| | ship-to-shore cranes to load/unload |
| | zone |
| 144 | line/arrow unloaded AGVs from |
| | load/unload station to ship-to-shore |
| | cranes |
| 145 | line/arrow loaded AGVs from |
| | ship-to-shore cranes to load/unload zone |
| 146 | line/arrow loaded AGVs from ship-to- |
| | shore cranes to load/unload zone |
| 147 | line/arrow unloaded AGVs from |
| | load/unload zone ship-to-shore cranes |
| 148 | line/arrow unloaded AGVs from ship-to- |
| | shore cranes to load/unload zone |
| 149 | line/arrow loaded AGVs from ship-to- |
| | shore cranes to load/unload zone |
| 150 | line/arrow 150 represents possible route |
| | exceptions |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A cargo container transportation system comprising:
a) a first terminal having a load/unload zone including at least one lifting device and at least one transfer vehicle and one or more other zones that are selected from: a maintenance zone, a refrigeration zone, a storage zone, and a passenger station;
b) a transportation line including an inbound line and an outbound line on which a plurality of pods that are each automated and adapted to carry a container can be transported, wherein said plurality of pods are electrically powered; and
c) a control station including software adapted to send instructions that control: i) movement of the plurality of pods along the transportation line, ii) movement of the at least one transfer vehicle between the load/unload zone and other zones at the first terminal; iii) movement and synchronization of the at least one lifting device at the loading zone, and iv) tracking of individual containers from ship to train.

2. The system of claim 1 wherein the plurality of pods is spaced along the transportation line in intervals of less than one minute.

3. The system of claim 1 wherein the plurality of pods is spaced along the transportation line in intervals of between about 20 seconds to 1 minute.

4. The system of claim 1 wherein the plurality of pods is spaced along the transportation line in intervals of between about 20 seconds to 5 minutes.

5. The system of claim 1 wherein the first terminal is between about 3 to 6 acres (12,140.4 to 24, 281.1 square m).

6-41. (canceled)

42. The system of claim 1 wherein the pods are adapted to carry 2 containers.

43. The system of claim 1 wherein the pods are trainsets that are adapted to carry 3 to 40 containers.

44-47. (canceled)

48. A method of transporting shipping containers along a transportation line between terminal ends, the method comprising the steps of:
a) preparing a pre-transport stage at a first terminal end for when a trainset arrives at the first terminal end that is loaded with a first set of containers in a first set of container wagons and a second set of containers in a second set of container wagons by positioning a plurality of transfer vehicles near lifting members, wherein some of the transfer vehicles are a first set of loaded transfer vehicles having a third set of containers thereon and some are a first set of unloaded transfer vehicles, and wherein the lifting members are also near the first set of container wagons of the trainset;
b) completing a first stage of transport by:
i) using the plurality of lifting members to lift the first set of containers from the trainset and transfer the first set of containers to the first set of unloaded transfer vehicles effecting a first set of newly loaded transfer vehicles and causing the first set of newly loaded transfer vehicles to depart to another location at the first terminal end;
ii) moving the plurality of lifting members over the first set of loaded transfer vehicles; and
iii) moving a second set of unloaded transfer vehicles in position near the plurality of lifting members;
c) completing a second stage of transport by:
i) lifting the third set of containers from the first set of loaded transfer vehicles of step (b)(ii) and moving the third set of containers to the first set of container wagons of the trainset on the transportation line;
ii) causing the second set of unloaded transfer vehicles of step (b)(iii) to be in position under the lifting members; and
iii) moving a second set of loaded transfer vehicles that are loaded with a fourth set of containers in position near the lifting members;
d) completing a third stage of transport by moving the trainset on the transportation line to align the second set of container wagons having the second set of containers with the plurality of lifting members;
e) completing a fourth stage of transport by:
i) using the lifting members to transfer the second set of containers from the second set of container wagons to the second set of unloaded transfer vehicles of step (c)(ii) to effect a second set of newly loaded transfer vehicles and moving the second set of newly loaded transfer vehicles to another destination at the first terminal end;
ii) causing lifting members to be aligned over the second set of loaded transfer vehicles of step (c)(iii);
f) completing a fifth stage of transport by:
i) using lifting members to transfer the fourth set of containers to the second set of container wagons of the trainset; and
ii) causing the trainset to depart to a second terminal end; and
wherein steps (b) to (f) are completed in between about 2 to 10 minutes.

49. The method of claim 48, wherein each of the first set of containers, second set of containers, third set of containers and fourth set of containers includes 2 to 40 containers.

50. The method of claim 48, wherein each of the first set of containers, second set of containers, third set of containers and fourth set of containers includes 1 to 20 containers.

51. The method of claim 48, wherein each of the first set of containers, second set of containers, third set of containers and fourth set of containers includes 8 to 10 containers.

52-56. (canceled)

57. The method of claim 49, wherein the first stage occurs at a time interval from 0 to 40 seconds, wherein the second stage occurs at a time interval from 40 seconds to 1 minute 30 seconds, wherein the third stage occurs at a time interval from 1 minute 30 seconds to 2 minutes 30 seconds, wherein the fourth stage occurs at a time interval from 2 minutes 30 seconds to 3 minutes 10 seconds, and wherein the fifth stage occurs a time interval of 3 minutes 10 seconds to 4 minutes.

58. The method of claim 48 wherein stage 1, stage 2, stage 3, stage 4, and stage 5 are completed in 4 minutes.

59. (canceled)

60. The method of claim 48 wherein the first set of newly loaded transfer vehicles and/or the second set of newly loaded transfer vehicles depart to a port destination, a hub destination, a rail destination, or to a storage facility.

61-62. (canceled)

63. A method of transporting shipping containers along a transportation line between terminal ends, the method comprising the following steps:
a) preparing a pre-transport stage at a first terminal end for when a pod arrives at the first terminal end that is loaded with a first container by positioning at least a pair of transfer vehicles near a first lifting member, wherein one said transfer vehicle is a first loaded transfer vehicle having a second container thereon and the other said transfer vehicle is a first unloaded transfer vehicle, and wherein other lifting members are also positioned near a park position for the pod; and
b) completing transport by:
i) using the first lifting member to lift a said first container from the pod and transfer said first container to the first unloaded transfer vehicle effecting a first newly loaded transfer vehicle and causing the first newly loaded transfer vehicle to depart to another location at the first terminal end;
ii) causing the first lifting member to be aligned with the first loaded transfer vehicle;
iii) moving the second container from the first loaded transfer vehicle to the pod; and
iv) causing the pod to depart to a second terminal end.

64. The method of claim 63 wherein the pod includes more than one first containers and wherein in step (b) more than one unloaded transfer vehicle receives the more than one first containers and wherein in step (b) there are more than one loaded transfer vehicles having more than one second containers and the more than one second containers are transferred to the pod.

65. The method of claim 63 wherein step (b) takes 20 to 60 seconds.

66. The method of claim 63 wherein step (b) takes 40 seconds.

67. The method of claim 64 wherein step (b) takes 40 seconds to 5 minutes.

68. The method of claim 64 wherein step (b) takes 40 seconds to 20 minutes.

69. The method of claim 64 wherein step (b) takes 2 minutes to 10 minutes.

70. (canceled)
